(19) United States
(12) Patent Application Publication
(10) Pub. No.: US 2021/0410162 A1
(43) Pub. Date: Dec. 30, 2021

(54) APPARATUS AND METHOD FOR SELECTING RADIO ACCESS TECHNOLOGY FOR DIRECT COMMUNICATION BETWEEN TERMINALS IN WIRELESS COMMUNICATION SYSTEM

(71) Applicant: Samsung Electronics Co., Ltd., Suwon-si (KR)

(72) Inventors: Hyunjeong KANG, Suwon-si (KR); Sangkyu BAEK, Suwon-si (KR)

(21) Appl. No.: 17/291,971

(22) PCT Filed: Nov. 11, 2019
(86) PCT No.: PCT/KR2019/015250

§ 371 Date: May 6, 2021

(30) Foreign Application Priority Data
Nov. 9, 2018 (KR) 10-2018-0137421

(51) Int. Cl. H04W 72/12; H04W 72/14; H04W 76/30

(52) U.S. Cl. CPC H04W 72/1263; H04W 72/14; H04W 92/18; H04W 72/1231; H04W 76/30; H04W 72/1284

(57) ABSTRACT

The present disclosure relates to a communication method and system for converging a 5^{th}-Generation (5G) communication system for supporting higher data rates beyond a 4^{th}-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. A method of operating a terminal in a wireless communication system comprises the steps of: determining a V2X service requiring direct communication and selecting a radio access technology resource according to the V2X service; when it is determined that a terminal is located within the coverage of a base station, transmitting V2X service information to the base station and receiving, from the base station, radio access technology resource setting information according to the V2X service; when it is determined that the terminal belongs to a specific V2X service group, receiving, from a lead terminal of the corresponding service group, the radio access technology resource setting information according to the V2X service of the group; when it is determined that a cast session with another terminal is established for the specific V2X service, receiving the radio access technology resource setting information according to a V2X service to be used in the unicast session; and transmitting and receiving a V2X service packet by using the set radio access technology resource.

### CROSS-REFERENCE TO RELATED APPLICATIONS

This application is a 371 of International Application No. PCT/KR2019/015250 filed on Nov. 11, 2019, which claims priority to Korean Patent Application No. 10-2018-0137421 filed on Nov. 9, 2018, the disclosures of which are herein incorporated by reference in their entirety.

### BACKGROUND

### 1. Field

The disclosure relates to a wireless communication system, and more particularly, to an apparatus and a method for selecting a radio access technology to be used in packet transmission and reception in a direct communication scheme between UEs in a wireless communication system.

Further, the disclosure relates to a method and an apparatus by which a UE and a base station support multiple services in a mobile communication system.

### 2. Description of Related Art

To meet the demand for wireless data traffic having increased since deployment of 4G communication systems, efforts have been made to develop an improved 5G or pre-5G communication system. Therefore, the 5G or pre-5G communication system is also called a “Beyond 4G Network” or a “Post LTE System”.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G communication systems.

In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

In the 5G system, hybrid FSK and QAM modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have also been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, machine type communication (MTC), and machine-to-machine (M2M) communication may be implemented by beamforming, MIMO, and array antennas. Application of a cloud radio access network (RAN) as the above-described big data processing technology may also be considered an example of convergence of the 5G technology with the IoT technology.

Schemes for determining various types of radio resources are being discussed in a 5G system. For example, a direct communication scheme for a vehicle-to-everything (V2X) UE has been proposed. Furthermore, various discussions for further decreasing a communication time, further increasing reliability, and more efficiently supporting direct communication between UEs are underway.

Based on the discussion, the disclosure provides an apparatus and a method for supporting a vehicle communication service and data transmission that achieve a required high-reliability and low-latency value by providing a method of performing direct communication between UEs in a vehicle communication system.

For example, the UE may perform the V2X service through an ng-RAN (gNB) connected to a 5G core network or an E-UTRAN (ng-eNB) connected to a 5G core network through the ng-RAN or the E-UTRAN. According to another embodiment, when a base station (BS) (ng-RAN or ng-eNB) is connected to an evolved packet core (EPC) network, the V2X service may be performed through the BS. At this time, a V2X wireless interface which can be used for direct communication between UEs may be a Uu or a sidelink, and an LTE RAT or a new radio (NR) RAT may be used in the case of the sidelink. Accordingly, a method of determining a sidelink RAT which the UE uses to perform V2X transmission/reception should be provided.

### SUMMARY

The technical problems to be solved by embodiments of the disclosure are not limited to the above-mentioned technical problems, and technical problems which have not been mentioned may be clearly understood by those skilled in the art on the basis of the following description.

In accordance with an aspect of the disclosure, a method of operating a first UE includes: transmitting a first message including vehicle to everything (V2X)-related information on the first UE to a base station (BS); receiving a second message including information for selecting a sidelink radio access technology (RAT), based on the first message from the BS; and performing sidelink communication with a second UE, based on RAT information.

In some embodiments, the method may further include transmitting a sidelink buffer status report (BSR) for the RAT to the BS, based on the RAT information, wherein the BS allocates resources for the RAT, based on the sidelink BSR.

In some embodiments, the V2X-related information on the first UE may include at least one of a use case indicator, a service ID, a destination ID, a group ID, a quality of service (QoS) indicator, an RAT capability of the first UE, a service flow ID, a bearer ID, a 5G QoS indicator (5QI), a ProSe per-packet priority (PPPP), and a ProSe per-packet reliability (PPPR), and the information for selecting the sidelink RAT may include at least one of a sidelink RAT indicator, a frequency channel number, a TX profile, and a sidelink transmission scheme.

In some embodiments, the information for selecting the sidelink RAT may include an indicator indicating at least one of Release-14, Release-15, and Release-16, the indicator may include a TX profile corresponding to at least one of Release-14, Release-15, and Release-16, and the TX profile may include at least one of a modulation coding scheme (MCS), rate matching, transport block sizes (TBS) scaling, semi-persistent scheduling (SPS)/configured grant, and a one shot grant.

In accordance with another aspect of the disclosure, a method of operating a BS includes: receiving a first message including vehicle to everything (V2X)-related information on a first UE from the first UE; and transmitting a second message including information for selecting a sidelink radio access technology (RAT) to the first UE, based on the first message, wherein the first UE performs sidelink communication with a second UE, based on RAT information.

In accordance with another aspect of the disclosure, a first UE in a wireless communication system includes: a transceiver; and a controller connected to the transceiver, wherein the controller is configured to transmit a first message including vehicle to everything (V2X)-related information on a first UE to a BS, receive a second message including information for selecting a sidelink radio access technology (RAT) from the BS, based on the first message, and perform sidelink communication with a second UE, based on the RAT information.

In accordance with another aspect of the disclosure, a BS in a wireless communication system includes: a transceiver; and a controller connected to the transceiver, wherein the controller is configured to receive a first message including vehicle to everything (V2X)-related information on a first UE from the first UE and transmit a second message including information for selecting a sidelink radio access technology (RAT) to the first UE, based on the first message, and the first UE performs sidelink communication with a second UE, based on RAT information.

According to various embodiments of the disclosure, a method of operating a UE in a wireless communication system includes a process in which the UE determines a V2X service that requires sidelink direct communication, a process of determining a sidelink RAT through which the corresponding service is supported on the basis of a service preconfigured in the UE and sidelink RAT mapping information, receiving sidelink RAT indication information for the service by the BS, receiving sidelink RAT indication information for the service by the group lead UE, or receiving sidelink RAT indication information by the transmissions UE, and a process of transmitting and receiving a V2X packet for the service through the indicated sidelink RAT. When it is determined that the service supported by the UE is an ITS public service, the method includes a process of using a service preconfigured in the UE and using sidelink RAT mapping information and a process of transmitting and receiving a V2X packet for the service through the indicated sidelink RAT. When it is determined that the service supported by the UE is an MNO (provided by a mobile service company) ITS service, the method includes a process of receiving sidelink RAT indication information for the service in an MNO network and a process of transmitting and receiving a V2X packet for the service through the indicated sidelink RAT.

A process of transmitting and receiving V2X signaling required for configuring and managing a groupcast session by the UE includes a process of acquiring a sidelink RAT preconfigured in the UE or a process of acquiring sidelink RAT information determined by an indication of the BS, and a process of transmitting and receiving V2X signaling required for configuring and managing a groupcast session through the acquired sidelink RAT.

A process of transmitting and receiving V2X signaling required for configuring and managing a unicast session by the UE includes a process of acquiring a sidelink RAT preconfigured in the UE or a process of acquiring sidelink RAT information determined by an indication of the BS, and a process of transmitting and receiving V2X signaling required for configuring and managing a unicast session through the acquired sidelink RAT.

According to various embodiments, a UE apparatus in a wireless communication system includes a transceiver and at least one processor functionally connected to the transceiver. At least one processor controls V2X packet transmission and reception through an indicated sidelink RAT by transmitting a sidelink RAT configuration information request message including at least one piece of V2X service information, V2X group information, V2X bearer information, and V2X QoS information to the BS and receiving a sidelink RAT configuration information message including at least one piece of sidelink RAT information, transmission profile information, and sidelink frequency channel information from the BS when it is determined that the UE is within a BS coverage. At least one processor controls V2X packet transmission and reception by receiving preconfigured sidelink RAT configuration information mapped to at least one piece of V2X service information, V2X group information, V2X bearer information, and V2X QoS information when it is determined that the UE is not within a BS coverage.

Using an apparatus and a method according to various embodiments of the disclosure, it is possible to achieve a required reliability and low-latency value within vehicle communication by selecting a sidelink radio access technology for selecting sidelink resources to be used for direct communication between UEs in a vehicle communication system to provide a method of supporting a vehicle communication service that requires various QoS.

Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF THE DRAWINGS

FIG. 1 illustrates a wireless communication system according to various embodiments of the disclosure;

FIG. 2 illustrates the configuration of a BS in a wireless communication system according to various embodiments of the disclosure;

FIG. 3 illustrates the configuration of a UE in a wireless communication system according to various embodiments of the disclosure;

FIGS. 4A, 4B, and 4C illustrate the configuration of a communication unit in a wireless communication system according to various embodiments of the disclosure;

FIGS. 5A, 5B, and 5C illustrate situations in which direct communication between UEs is performed using a sidelink RAT according to various embodiments of the disclosure;

FIG. 5D illustrates an example of the use of an ITS frequency channel according to various embodiments of the disclosure;

FIGS. 6A and 6B illustrate procedures between a UE and a BS for configuring a sidelink RAT for direct communication between UEs according to various embodiments of the disclosure;

FIGS. 7A and 7B illustrate signal procedures between a BS and a UE acquiring sidelink resource allocation information on the basis of configured sidelink RAT information according to various embodiments of the disclosure;

FIGS. 8A, 8B, and 8C illustrate signal procedures between UEs exchanging sidelink RAT configuration information for groupcast according to various embodiments of the disclosure;

FIG. 9 illustrates a signal procedure between UEs exchanging sidelink RAT configuration information for unicast according to various embodiments of the disclosure;

FIGS. 10A and 10B illustrate signal procedures between UEs exchanging sidelink RAT configuration information in a platooning scenario according to various embodiments of the disclosure;

FIG. 11 illustrates a signal procedure between a BS and a UE exchanging sidelink RAT configuration information on the basis of an entity that manages an ITS service according to various embodiments of the disclosure;

FIG. 12 illustrates an operation process in which the UE allocates an MAC control element (CE) and data to a MAC PDU;

FIG. 13 illustrates a detailed operation process in which the UE allocates a MAC control element (CE) and data to a MAC PDU;

FIG. 14 illustrates an example in which a data transmission delay is generated by a MAC CE having a higher priority than data;

FIG. 15 illustrates a method of configuring priority groups of logical channels proposed in the disclosure;

FIG. 16 illustrates a logical channel prioritization method according to a priority group configuration proposed in the disclosure;

FIG. 17 illustrates a method of configuring a priority group of a logical channel proposed in the disclosure;

FIG. 18 illustrates a logical channel prioritization method according to a priority group configuration proposed in the disclosure;

FIG. 19 illustrates another embodiment of the logical channel prioritization method according to the priority group configuration proposed in the disclosure;

FIG. 20 illustrates an example of a logical channel prioritization method proposed in the disclosure;

FIG. 21 illustrates an embodiment in which the BS allocates priority groups when logical channels are generated;

FIG. 22 illustrates an embodiment of a method of distinguishing BSRs having different priorities;

FIG. 23 illustrates a structure of a BS according to an embodiment of the disclosure; and

FIG. 24 illustrates a structure of a UE according to an embodiment of the disclosure.

### DETAILED DESCRIPTION

Hereinafter, embodiments of the disclosure will be described in detail with reference to the accompanying drawings. It should be noted that, in the drawings, the same or like elements are designated by the same or like reference signs as much as possible. Further, a detailed description of known functions or configurations that may make the subject matter of the disclosure unclear will be omitted.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Here, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card.

In the following description, terms referring to signals, terms referring to control information, terms referring to network entities, terms referring to device elements, and the like are illustratively used for the sake of convenience. Therefore, the disclosure is not limited by the terms as used below, and other terms referring to subjects having equivalent technical meanings may be used.

Further, various embodiments of the disclosure will be described using terms used in the 3rd generation partnership project (3GPP), but they are illustrated merely for the convenience of description. Various embodiments of the disclosure may be applied to other communication systems through modifications and changes.

### Embodiment 1

Hereinafter, the disclosure relates to an apparatus and a method for determining radio resources in a wireless communication system. Specifically, the disclosure describes a technology for satisfying a quality of service (QoS) level required for various V2X services on the basis of a method of selecting sidelink radio access technology resources for sidelink direct communication between UEs (vehicle to everything (V2X)) in a wireless communication system.

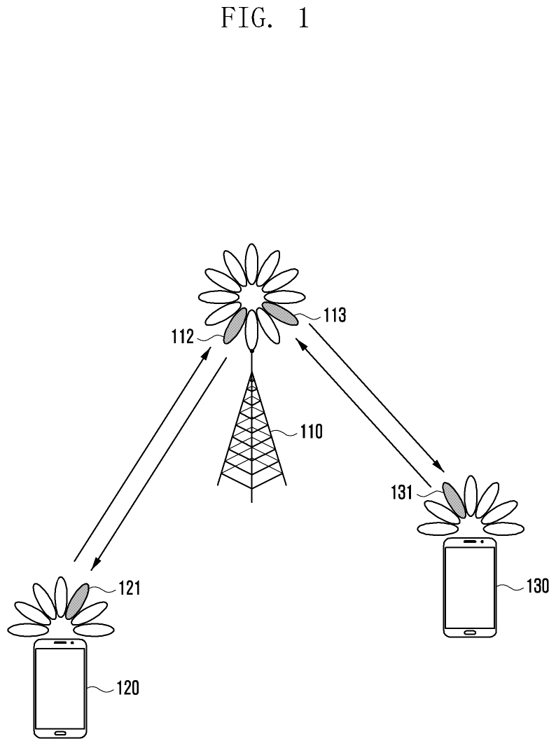

FIG. 1 illustrates a wireless communication system according to various embodiments of the disclosure. FIG. 1 illustrates a base station (BS) 110, a UE 120, and a UE 130 as some of the nodes using a radio channel in a wireless communication system. FIG. 1 illustrates only one BS but may further include another BS, which is the same as or similar to the BS 110. FIG. 1 illustrates only two UEs, but may further include another UE which is the same as or similar to the UE 120 and the UE 130.

The BS 110 is a network infrastructure element that provides radio access to the UEs 120 and 130. The BS 110 has coverage defined as a predetermined geographical region based on the distance at which a signal can be transmitted. The BS 110 may be referred to as an “access point (AP)”, “eNodeB (eNB)”, “5^{th}-generation (5G) node”, “5G NodeB (gNodeB or gNB)”, “wireless point”, “transmission/reception point (TRP)”, or another term having a technical meaning equivalent thereto, as well as “base station”.

Each of the UEs 120 and 130 is an apparatus used by a user and may communicate with the BS 110 through a radio channel. Depending on the case, at least one of the UEs 120 and 130 may operate without user involvement. That is, at least one of the UEs 120 and 130 may be an apparatus that performs Machine-Type Communication (MTC), and may not be carried by the user. Each of the UEs 120 and 130 may be referred to as “user equipment (UE)”, “mobile station”, “subscriber station”, “remote terminal”, “wireless terminal”, “user device”, or another term having the equivalent technical meaning, as well as “terminal”.

The BS 110, the UE 120, and the UE 130 may transmit and receive a wireless signal in millimeter-wave (mmWave) bands (for example, 28 GHz, 30 GHz, 38 GHz, and 60 GHz). At this time, in order to increase a channel gain, the BS 110, the UE 120, and the UE 130 may perform beamforming. The beamforming may include transmission beamforming and reception beamforming. That is, the BS 110, the UE 120, and the UE 130 may assign directivity to a transmission signal or a reception signal. To this end, the BS 110 and the UEs 120 and 130 may select serving beams 112, 113, 121, and 131 through a beam search procedure or a beam management procedure. After the serving beams 112, 113, 121, and 131 are selected, communication may be performed through resources having a quasi-co-located (QCL) relationship with resources through which the serving beams 112, 113, 121, and 131 are transmitted.

If the large-scale characteristics of a channel for transmitting symbols through a first antenna port can be inferred from a channel for transmitting symbols through a second antenna port, the first antenna port and the second antenna port may be evaluated to have a QCL relationship therebetween. For example, the large-scale characteristics may include at least one of delay spread, Doppler spread, Doppler shift, average gain, average delay, and spatial receiver parameters.

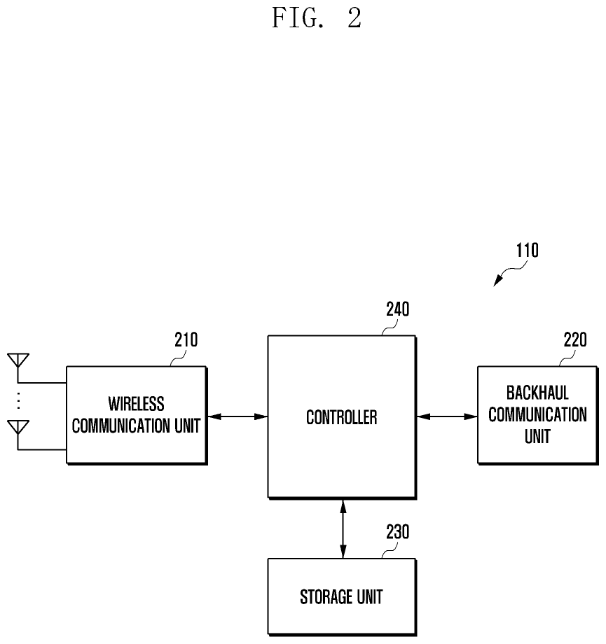

FIG. 2 illustrates the configuration of a BS in a wireless communication system according to various embodiments of the disclosure. The configuration illustrated in FIG. 2 may be understood as the configuration of the BS 110. The term “ . . . unit”, or the ending of a word, such as “ . . . or”, “ . . . er”, or the like, may indicate a unit of processing at least one function or operation, which may be embodied in hardware, software, or a combination of hardware and software.

Referring to FIG. 2, the BS may include a wireless communication unit 210, a backhaul communication unit 220, a storage unit 230, and a controller 240.

The wireless communication unit 210 may perform functions for transmitting and receiving a signal through a radio channel. For example, the wireless communication unit 210 may perform a conversion function between a baseband signal and a bitstream according to a physical layer standard of the system. For example, in data transmission, the wireless communication unit 210 may generate complex symbols by encoding and modulating a transmission bitstream. In data reception, the wireless communication unit 210 may reconstruct a reception bitstream by demodulating and decoding a baseband signal.

Furthermore, the wireless communication unit 210 may up-convert a baseband signal into a radio frequency (RF) band signal and then transmit the same through an antenna, and may down-convert an RF band signal received through an antenna into a baseband signal. To this end, the wireless communication unit 210 may include a transmission filter, a reception filter, an amplifier, a mixer, an oscillator, a digital-to-analog convertor (DAC), an analog-to-digital convertor (ADC), and the like. The wireless communication unit 210 may include a plurality of transmission/reception paths. The wireless communication unit 210 may include at least one antenna array including a plurality of antenna elements.

On the hardware side, the wireless communication unit 210 may include a digital unit and an analog unit, and the analog unit may include a plurality of sub-units according to operation power, operation frequency, and the like. The digital unit may be implemented by at least one processor (for example, a digital signal processor (DSP)).

The wireless communication unit 210 transmits and receives the signal as described above. Accordingly, all or part of the wireless communication unit 210 may be referred to as a “transmitter”, a “receiver”, or a “transceiver”. Also, in the following description, the transmission and reception performed through a radio channel may be understood to mean that the above-described processing is performed by the wireless communication unit 210.

The backhaul communication unit 220 may provide an interface for communicating with other nodes within the network. That is, the backhaul communication unit 220 may convert a bitstream transmitted from the BS to another node, for example, another access node, another BS, a higher node, or a core network into a physical signal and convert a physical signal received from another node into a bitstream.

The storage unit 230 may store data such as a basic program, an application, and configuration information for operating the BS. The storage unit 230 may include volatile memory, nonvolatile memory, or a combination of volatile memory and nonvolatile memory. The storage unit 230 may provide the stored data in response to a request from the controller 240.

The controller 240 may control the overall operation of the BS. For example, the controller 240 may transmit and receive a signal through the wireless communication unit 210 or through the backhaul communication unit 220. The controller 240 may record data in the storage unit 230 and read the same. The controller 240 may perform the functions of a protocol stack required for communication standards. According to another implementation, the protocol stack may be included in the wireless communication unit 210. To this end, the controller 240 may include at least one processor.

According to various embodiments, the controller 240 may transmit radio resource control (RRC) configuration information to the UE 110. The controller 240 may transmit sidelink configuration information to the UE 110. For example, the controller 240 may control the BS to perform the operations according to various embodiments described below.

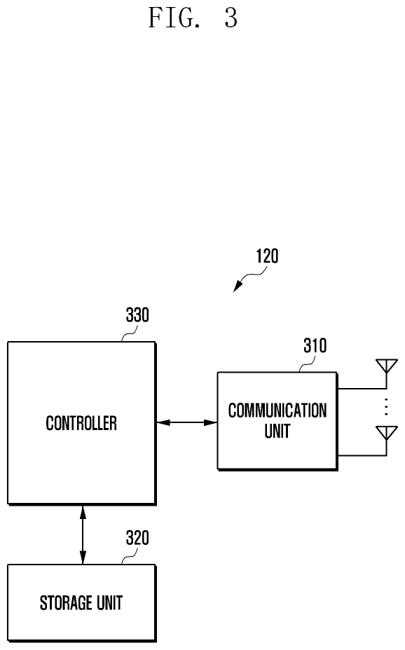

FIG. 3 illustrates a configuration of the UE in a wireless communication system according to various embodiments of the disclosure. The configuration illustrated in FIG. 3 may be understood as the configuration of the UE 120 or the UE 130. The term “ . . . unit”, or the ending of a word, such as “ . . . or”, “ . . . er”, or the like, may indicate a unit of processing at least one function or operation, which may be embodied in hardware, software, or a combination of hardware and software.

Referring to FIG. 3, the UE may include a communication unit 310, a storage unit 320, and a controller 330.

The communication unit 310 may perform functions for transmitting and receiving a signal through a radio channel. For example, the communication unit 310 may perform a conversion function between a baseband signal and a bitstream according to a physical layer standard of the system. For example, in data transmission, the communication unit 310 may generate complex symbols by encoding and modulating a transmission bitstream. In data reception, the communication unit 310 may reconstruct a reception bitstream by demodulating and decoding a baseband signal. The communication unit 310 may up-convert a baseband signal into an RF band signal and then transmit the same through an antenna, and may down-convert an RF band signal received through an antenna into a baseband signal. For example, the communication unit 310 may include a transmission filter, a reception filter, an amplifier, a mixer, an oscillator, a DAC, an ADC, and the like.

The communication unit 310 may include a plurality of transmission/reception paths. The communication unit 310 may include at least one antenna array including a plurality of antenna elements. On the hardware side, the communication unit 310 may include a digital circuit and an analog circuit (for example, a radio frequency integrated circuit (RFIC)). The digital circuit and the analog circuit may be implemented as one package. The communication unit 310 may include a plurality of RF chains. The communication unit 310 may perform beamforming.

The communication unit 310 may include different communication modules to process signals in different frequency bands. The communication unit 310 may include a plurality of communication modules to support a plurality of different radio-access technologies. For example, the different radio access technologies may include Bluetooth low energy (BLE), wireless fidelity (Wi-Fi), Wi-Fi Gigabyte (WiGig), and cellular network (for example, long-term evolution (LTE)). Furthermore, different frequency bands may include a super high frequency (SHF) (for example, 2.5 GHz, 3.5 GHz, and 5 GHz) band and a millimeter (mm) wave (for example, 60 GHz) band.

The communication unit 310 may transmit and receive a signal as described above. Accordingly, all or some of the communication unit 310 may be referred to as a “transmitter”, a “receiver”, or a “transceiver”. Also, in the following description, the transmission and reception performed through a radio channel may be understood to mean that the above-described processing is performed by the communication unit 310.

The storage unit 320 may store data such as a basic program, an application, and configuration information for operating the UE. The storage unit 320 may include volatile memory, nonvolatile memory, or a combination of volatile memory and nonvolatile memory. The storage unit 320 may provide the stored data in response to a request from the controller 330.

The controller 330 may control the overall operation of the UE. For example, the controller 330 may transmit and receive signals through the communication unit 310. The controller 330 may record data in the storage unit 320 and read the same. The controller 330 may perform functions of the protocol stack required by the communication standard. To this end, the controller 330 may include at least one processor or microprocessor, or may play the part of the processor. Furthermore, the part of the communication unit 310 or the controller 330 may be referred to as a Communication Processor (CP).

According to various embodiments, when the UE 120 performs sidelink direct communication with another UE, the controller 330 may perform a process in which the UE 120 determines service information required by a V2X application and transmitting the V2X service information to the BS, a process of acquiring radio access technology information to be used for transmitting and receiving the V2X service, frequency channel information on resources for transmitting and receiving the V2X service, transmission mode information for transmitting and receiving the V2X service, and transmission profile information for transmitting and receiving the V2X service from the BS, and a process of transmitting and receiving the V2X service using resources of the acquired radio access technology information. For example, the controller 330 may control the UE to perform the operations described below according to various embodiments.

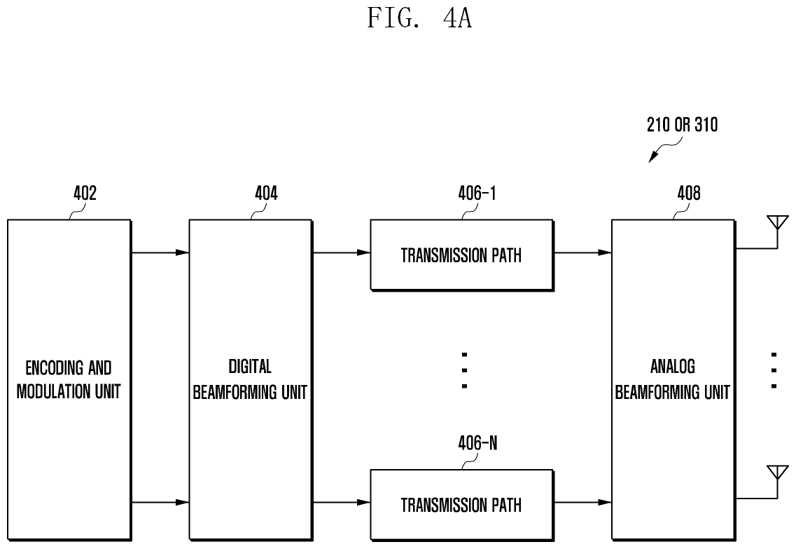

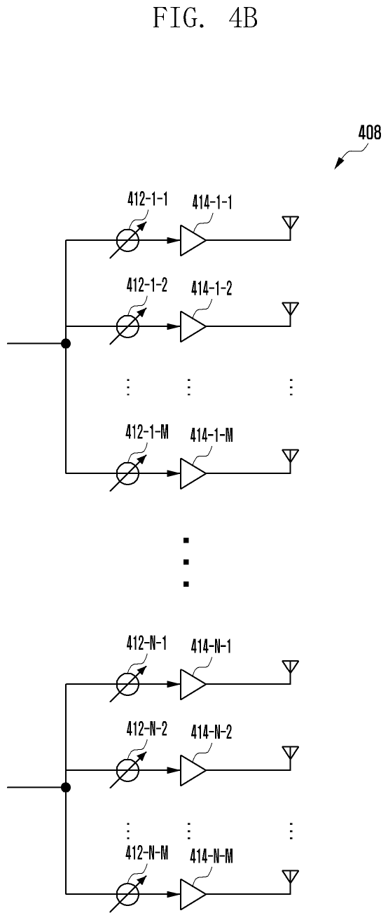

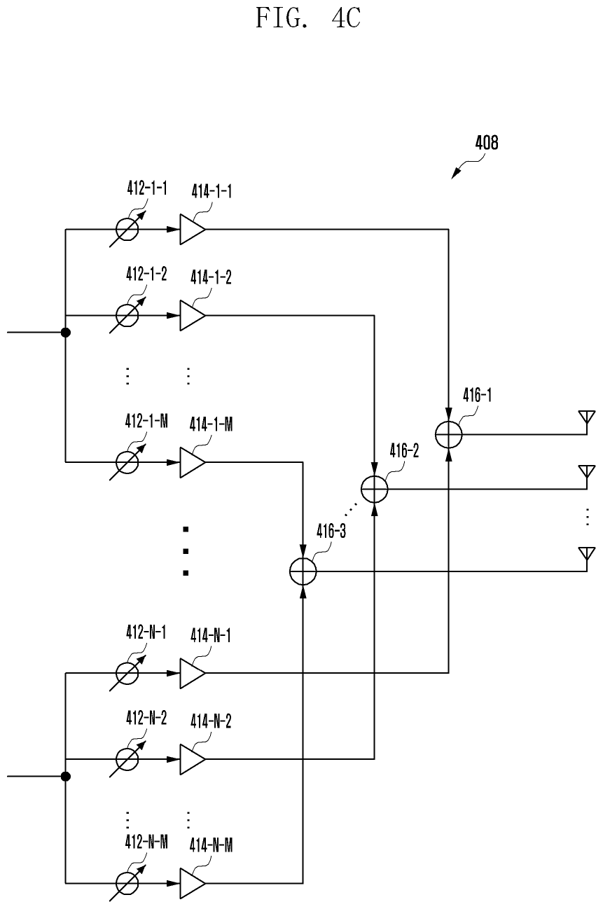

FIGS. 4A, 4B, and 4C illustrate the configuration of a communication unit in a wireless communication system according to various embodiments of the disclosure. FIGS. 4A, 4B, and 4C illustrate the detailed configuration of the wireless communication unit 210 of FIG. 2 or the communication unit 310 of FIG. 3. Specifically, FIGS. 4A, 4B, and 4C illustrate elements for performing beamforming as the part of the wireless communication unit 210 of FIG. 2 or the communication unit 310 of FIG. 3.

Referring to FIG. 4A, the wireless communication unit 210 or the communication unit 310 includes an encoding and modulation unit 402, a digital beamforming unit 404, a plurality of transmission paths 406-1 to 406-N, and an analog beamforming unit 408.

The encoding and modulation unit 402 performs channel encoding. For the channel encoding, at least one of a low-density parity check (LDPC) code, a convolution code, and a polar code may be used. The encoding and modulation unit 402 generates modulation symbols by performing constellation mapping.

The digital beamforming unit 404 performs beamforming on a digital signal (for example, modulation symbols). To this end, the digital beamforming unit 404 multiplies the modulation symbols by beamforming weighted values. The beamforming weighted values may be used for changing the magnitude and phase of the signal, and may be referred to as a “precoding matrix” or a “precoder”. The digital beamforming unit 404 outputs digitally beamformed modulation symbols through the plurality of transmission paths 406-1 to 406-N. At this time, according to a multiple-input multiple-output (MIMO) transmission scheme, the modulation symbols may be multiplexed, or the same modulation symbols may be provided through the plurality of transmission paths 406-1 to 406-N.

The plurality of transmission paths 406-1 to 406-N convert the digitally beamformed digital signals into analog signals. To this end, each of the plurality of transmission paths 406-1 to 406-N may include an inverse fast Fourier transform (IFFT) calculation unit, a cyclic prefix (CP) insertion unit, a DAC, and an up-conversion unit. The CP inserter is for an orthogonal frequency division multiplexing (OFDM) scheme, and may be omitted when another physical layer scheme (for example, a filter bank multi-carrier (FBMC)) is applied. That is, the plurality of transmission paths 406-1 to 406-N provides independent signal-processing processes for a plurality of streams generated through the digital beamforming. However, depending on the implementation, some of the elements of the plurality of transmission paths 406-1 to 406-N may be used in common.

The analog beamforming unit 408 performs beamforming on analog signals. To this end, the digital beamforming unit 404 multiplies the analog signals by beamforming weighted values. The beamformed weighted values are used to change the magnitude and phase of the signal. More specifically, the analog beamforming unit 408 may be configured as illustrated in FIG. 4B or 4C according to a connection structure between the plurality of transmission paths 406-1 to 406-N and the antennas.

Referring to FIG. 4B, signals input into the analog beamforming unit 408 may be transmitted through the antennas via phase/size conversion and amplification operation. At this time, the signals in respective paths are transmitted through different antenna sets, that is, antenna arrays. In the processing of signals input through a first path, the signals are converted into signal sequences having the same or different phases/sizes by phase/size conversion units 412-1-1 to 412-1-M, amplified by amplifiers 414-1-1 to 414-1-M, and transmitted through antennas.

Referring to FIG. 4C, the signals input into the analog beamforming unit 408 are transmitted through the antennas via phase/size conversion and amplification operation. At this time, the signals in respective paths are transmitted through the same antenna set, that is, antenna array. In the processing of signals input through the first path, the signals are converted into signal sequences having the same or different phase/size by the phase/size conversion units 412-1-1 to 412-1-M and amplified by the amplifiers 414-1-1 to 414-1-M. Further, in order to be transmitted through one antenna array, the amplified signals are summed up by summing units 416-1-1 to 416-1-M based on antenna element and then transmitted through the antennas.

FIG. 4B illustrates an example in which an independent antenna array is used for each transmission path, and FIG. 4C illustrates an example in which transmission paths share one antenna array. However, according to another embodiment, some transmission paths may use independent antenna arrays and the remaining transmission paths may share one antenna array. Further, according to yet another embodiment, a structure that may adaptively vary depending on the situation may be used by applying a switchable structure between transmission paths and antenna arrays.

A V2X service may be divided into a basic safety service and an advanced service. The basic safety service may correspond to detailed services such as a vehicle notification (CAM or BSM) service, a left-turn notification service, a forward collision warning service, an approaching emergency vehicle notification service, a forward obstacle warning service, and an intersection signal information service, and may transmit and receive V2X information through a broadcast, unicast, or groupcast transmission scheme. The advanced service has more stringent QoS requirements compared to the basic safety service, and needs a scheme of transmitting and receiving V2X information through unicast and groupcast transmission schemes as well as the broadcast transmission scheme, in order to transmit and receive V2X information within a specific vehicle group or to transmit and receive V2X information between two vehicles. The advanced service may correspond to detailed services such as a platooning service, an autonomous driving service, a remote driving service, and an extended sensor-based V2X service. The disclosure describes a method of selecting radio access technology resources for performing a direct communication scheme between vehicles required for a basic safety service or an advanced service according to various embodiments.

Methods according to embodiments stated in claims and/or specifications of the disclosure may be implemented in hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The one or more programs may include instructions for allowing the electronic device to perform methods according to embodiments stated in the claims and/or specifications of the disclosure.

The programs (software modules or software) may be stored in non-volatile memories including a random access memory and a flash memory, a Read Only Memory (ROM), an Electrically Erasable Programmable Read Only Memory (EEPROM), a magnetic disc storage device, a Compact Disc-ROM (CD-ROM), Digital Versatile Discs (DVDs), or other type optical storage devices, or a magnetic cassette. Alternatively, the programs may be stored in a memory including any combination of some or all thereof. Furthermore, the number of such memories may be plural.

In addition, the programs may be stored in an attachable storage device which may access the electronic device through communication networks such as the Internet, Intranet, local area network (LAN), wide LAN (WLAN), and storage area network (SAN) or a combination thereof. The storage device may access a device performing embodiments of the disclosure through an external port. The separate storage device in a communication network may access the device performing embodiments of the disclosure.

In the detailed embodiments of the disclosure, elements included in the disclosure are expressed in a singular or plural form according to the presented detailed embodiment. However, the singular or plural expression is selected to be suitable for context for convenience of description, and the disclosure is not limited to a singular element or plural elements. Even elements expressed in the plural form may be configured as a singular, and even an element expressed in the singular form may be configured as a plural.

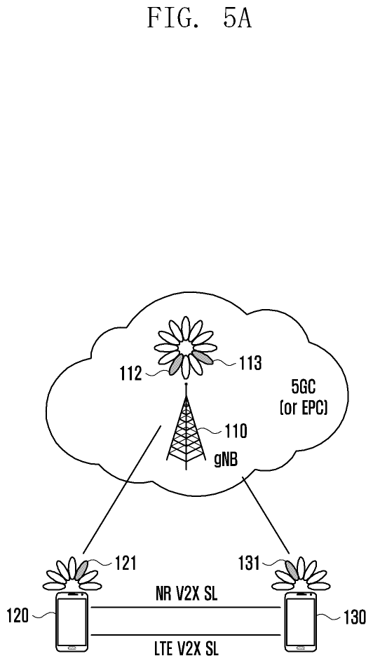

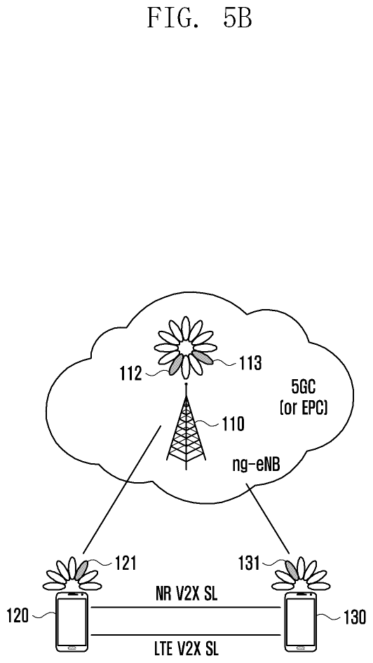

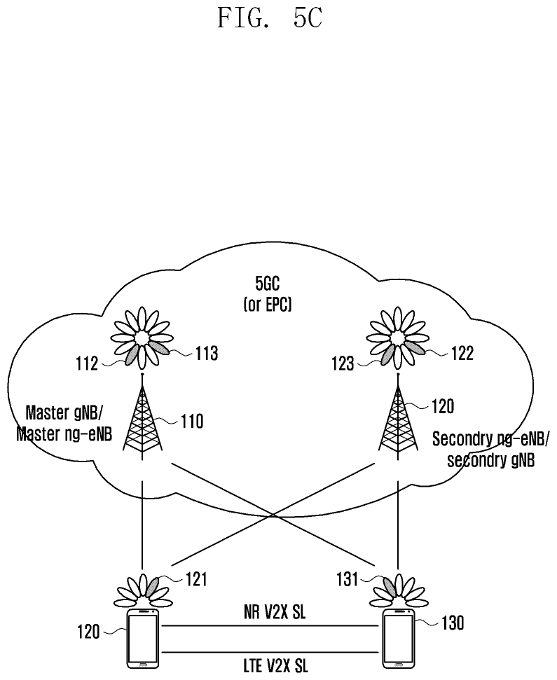

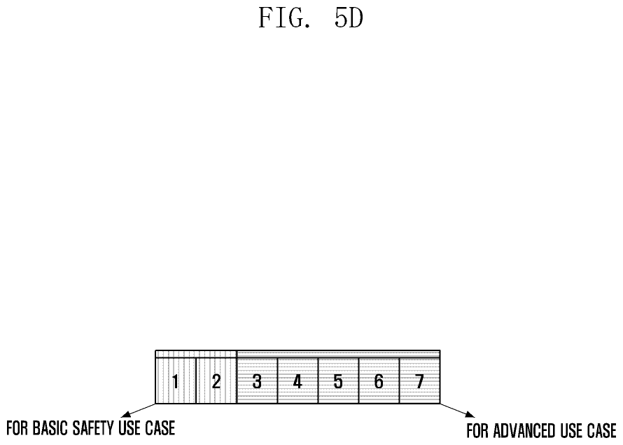

FIGS. 5A, 5B, and 5C illustrate situations in which direct communication between UEs is performed using a sidelink RAT according to various embodiments of the disclosure.

Referring to FIG. 5A, the UE performs a V2X service through an ng-RAN in the ng-RAN (gNB) connected to a 5G core network or an evolved packet core network (EPC). A V2X interface which can be used for direct communication between UEs may be a Uu or a sidelink, and the UE may use a sidelink protocol based on an LTE RAT or a sidelink protocol based on an NR RAT for V2X communication using a sidelink.

Referring to FIG. 5B, the UE performs a V2X service through an E-UTRAN in the E-UTRAN (ng-eNB) connected to a 5G core network or an evolved packet core network (EPC). A V2X interface which can be used for direct communication between UEs may be a Uu or a sidelink, and the UE may use a sidelink protocol based on an LTE RAT or a sidelink protocol based on an NR RAT for V2X communication using a sidelink.

Referring to FIG. 5C, cross RAT control of a gNB or an ng-eNB connected to a 5G core network or an evolved packet core network (EPC), for example, an eNB controls an NR V2X sidelink or a gNB controls an LTE V2X sidelink. A cross RAT control scenario may include a scenario in which an NR V2X sidelink and an LTE V2X sidelink are controlled in MR-DC (eNB is MN and gNB is SN or gNB is MN and eNB is SN). As illustrated in the embodiment of FIG. 5C, the UE may use a sidelink RAT which is the same as an RAT of a master BS to transmit and receive a V2X packet in a mixed scenario. For example, an LTE sidelink protocol may be selected when the master BS of the transmission UE is an eNB, and an NR sidelink protocol may be used when the master BS of the transmission UE is a gNB. According to another embodiment, the UE may use a sidelink RAT indicated by the master BS to transmit and receive a V2X packet in a mixed scenario. According to another embodiment, the UE may select an LTE sidelink protocol to transmit and receive a V2X packet for a basic safety service and select an NR sidelink protocol to transmit and receive a V2X packet for the advanced use case in a mixed scenario.

A method by which the UE selects a sidelink RAT for transmitting and receiving a V2X packet according to various embodiments of the disclosure is described below.

(1) Basic Mapping Rule

In the use case for the basic safety service, a V2X packet may be transmitted and received using an LTE RAT, that is, an LTE sidelink protocol. In the use case for the advanced V2X service, a V2X packet may be transmitted and received using an NR RAT, that is, an NR sidelink protocol.

According to another embodiment of the basic mapping rule, in the use case for the advanced V2X service, the LTE sidelink protocol and the NR sidelink protocol may be separately used depending on a level of QoS requirements. For example, the NR sidelink protocol may be used when the advanced use case requires more stringent QoS requirements and the LTE sidelink protocol may be used when the advanced use case requires less stringent QoS requirements.

According to another embodiment of the basic mapping rule, the LTE sidelink protocol and the NR sidelink protocol may be separately used depending on an operation frequency and a used channel. For example, the LTE sidelink protocol may be used when a channel in a band of 5.9 GHz is used, and the NR sidelink protocol may be used when a channel in a band of 6 GHz is used.

(2) RAT Configuration for Each Sidelink Scheduling Mode

When the UE is in an RRC connected state, the UE operates under the control of the BS, and thus the BS may configure a sidelink scheduling mode and a sidelink RAT according thereto. The BS may select an RAT in consideration of wireless and network statuses.

When the UE is in an RRC idle state or an RRC inactive state, the UE may operate in a mode in which the UE selects sidelink resources by itself and may select a sidelink protocol according to the basic mapping rule. According to another embodiment, the UE may select a predetermined sidelink protocol in a V2X service group. According to another embodiment, the UE may select a predetermined sidelink protocol in a V2X unicast session.

(3) RAT Configuration According to an ITS Public Service and an MNO Service

In the use case corresponding to an ITS public service, a sidelink RAT protocol may be selected through the application of the basic mapping rule. In the use case corresponding to an MNO service, a sidelink RAT protocol indicated by a network may be selected. The network may select an RAT in consideration of wireless and network statuses.

(4) RAT Configuration for Each Transmission Scheme

When a V2X packet is transmitted and received using a broadcast scheme, a sidelink RAT may be configured through the application of the basic mapping rule. When a V2X packet is transmitted and received using a unicast or groupcast scheme, a sidelink RAT may be configured through the application of the basic mapping rule or according to an indication of a BS, a group lead UE, or a transmission UE of a unicast session.

(5) RAT Configuration for Each V2X Sidelink Protocol Version

According to an embodiment of the disclosure, a V2X version which the UE can support may include an LTE-based sidelink or an NR-based sidelink.

In an embodiment, if the UE supports only an LTE-based sidelink version, a V2X packet may be transmitted and received using the LTE RAT in the use case for the basic safety service. In another embodiment, if the UE supports only an NR-based sidelink version, a V2X packet may be transmitted and received using the NR RAT in the use case for the basic safety service. If the UE transmits and receives a V2X packet corresponding to the use case of the basic safety service using the NR-based sidelink version, the UE may use LTE-based sidelink numerology in order to transmit and receive the V2X packet. The LTE-based sidelink numerology may be defined as one of pieces of V2X packet transmission/reception profile information on an NR-based sidelink version protocol (for example, see [Table 7] described below). At this time, the V2X packet transmission/reception profile information may be set as a parameter value by which even the UE supporting only the LTE-based sidelink version can decode the V2X packet. The V2X packet transmission/reception profile information may be provided to the UE supporting the NR-based sidelink version protocol through a method using a parameter included in a system broadcasting information message, a parameter included in an RRC control message, or a preset parameter. The NR-based sidelink version protocol may define an indicator indicating whether the transmission UE should use the LTE-based sidelink numerology. The indicator may be included in the V2X packet, and may use at least one of a 5G QoS indicator (5QI) corresponding to the use case for the basic safety service, an indicator using the LTE-based sidelink numerology, and a V2X packet transmission/reception profile indicator set as the LTE RAT. The NR-based sidelink version protocol may define an indicator indicating whether the transmission UE should use the NR-based sidelink numerology. The indicator may be included in the V2X packet, and may use at least one of a 5G QoS indicator (5QI) corresponding to the use case for the advanced V2X service, an indicator using the NR-based sidelink numerology, and a V2X packet transmission/reception profile indicator set as the NR RAT.

According to another embodiment, if the UE supports both the LTE-based sidelink version and the NR-based sidelink version, the UE may transmit and receive a V2X packet using the LTE RAT in the use case for the basic safety service and transmit and receive a V2X packet using the NR RAT in the use case for the advanced V2X service.

According to an embodiment of the disclosure, when the sidelink RAT is configured according to an indication of the BS, the group lead UE, or the transmission UE of the unicast session, the sidelink RAT may be selected in consideration of sidelink RAT capability of UEs participating in V2X packet transmission/reception (a protocol version that can be supported, the number of transmission/reception antennas, a supported frequency channel, and the like).

According to various embodiments of the disclosure, sidelink RAT selection configuration information used by the UE and the network is described below.

RAT selection configuration information including [Table 1] to [Table 5] below may be configured in the UE in advance or may be acquired through signaling between the UE and the network such as Q&M signaling or network management signaling (NMS). RAT selection configuration information in [Table 1] to [Table 5] may be configured in the network (or BS) and may be used to indicate sidelink RAT configuration to the UE with reference to [Table 1] to [Table 5] when the UE makes a request for RAT configuration to the network. The RAT selection configuration information in [Table 1] to [Table 5] may be updated according to a V2X management condition.

[Table 1] below shows an embodiment of sidelink RAT configuration for each use case for V2X service.

TABLE 1

| V2X use cases | Indicator | RAT type |
|---|---|---|
| Basic safety service 1 (left turn assist) | Service ID 1 | LTE |
| Basic safety service 2 (electric emergency | Service ID 2 | LTE |
| brake light) | | |
| . . . | . . . | |
| Advanced use case 1 (autonomous | Service ID 11 | NR |
| driving) | | |
| Advanced use case 2 (extended sensor | Service ID 12 | NR |
| sharing) | | |
| Advanced use case 3 (platooning - group | Service ID 13 | NR |
| join) | | |

For example, each of the use cases corresponding to the basic safety service and the advanced service may be indicated by a service ID, and a sidelink RAT type for V2X packet transmission/reception corresponding to the service ID may be configured. According to the embodiment of [Table 1] above, the use case for the basic safety service may be configured to select the LTE sidelink RAT, and the use case for the advanced service may be configured to select the NR sidelink RAT.

[Table 2] shows another embodiment of sidelink RAT configuration for each use case for V2X service.

TABLE 2

| V2X use cases | Indicator | RAT type |
|---|---|---|
| Basic safety service 1 (left turn assist) | Service ID 1 | LTE |
| Basic safety service 2 (electric emergency | Service ID 2 | LTE |
| brake light) | | |
| . . . | . . . | |
| Advanced use case 1 (autonomous | Service ID 11 | NR |
| driving) | | |
| Advanced use case 2 (extended sensor | Service ID 12 | NR |
| sharing) | | |
| Advanced use case 3 (platooning - group | Service ID 13 | LTE |
| join) | | |

For example, each of the use cases corresponding to the basic safety service and the advanced service may be indicated by a service ID, and a sidelink RAT type for V2X packet transmission/reception corresponding to the service ID may be configured. According to the embodiment of [Table 2] above, the use case for the basic safety service may be configured to select the LTE sidelink RAT, and the use case for the advanced service may be configured to select the LTE sidelink RAT and the NR sidelink RAT depending on a QoS requirement level. According to the embodiment of [Table 2] above, the QoS level required by advanced use case 2 (extended sensor sharing) is more stringent and thus is configured to select the NR sidelink RAT. The QoS level required by advanced use case 3 (platooning group join) is less stringent and thus is configured to select the LTE sidelink RAT.

[Table 3] below shows another embodiment of sidelink RAT configuration for each use case for V2X service.

TABLE 3

| | | RAT type |
|---|---|---|
| | | with radio |
| V2X use cases | Indicator | version |
| Basic safety service 1 (left turn assist) | Service ID 1 | LTE rel-14 |
| Basic safety service 2 (electric emergency | Service ID 2 | LTE rel-14 |
| brake light) | | |
| . . . | . . . | |
| Advanced use case 1 (autonomous | Service ID 11 | NR rel-16 |
| driving) | | |
| Advanced use case 2 (extended sensor | Service ID 12 | NR rel-16 |
| sharing) | | |
| Advanced use case 3 (platooning - group | Service ID 13 | LTE rel-15 |
| join) | | |

For example, each of the use cases corresponding to the basic safety service and the advanced service may be indicated by a service ID, and a sidelink RAT type for V2X packet transmission/reception corresponding to the service ID may be configured. The sidelink RAT type may be expressed by sidelink protocol version information. According to the embodiment of [Table 3] above, the use case for the basic safety service may be configured to select LTE sidelink protocol version 14, and the use case for the advanced service may be configured to select LTE sidelink protocol version 15 and NR sidelink protocol version 16 depending on a QoS requirement level. According to the embodiment of [Table 3] above, the QoS level required by advanced use case 2 (extended sensor sharing) is more stringent and thus is configured to select NR sidelink protocol version 16. The QoS level required by advanced use case 3 (platooning group join) is less stringent and thus is configured to select LTE sidelink protocol version 15.

[Table 4] below shows another embodiment of sidelink RAT configuration for each use case for V2X service.

TABLE 4

| | | Freq. | RAT type with |
|---|---|---|---|
| V2X use cases | Indicator | channel | radio version |
| Basic safety service 1 (left turn assist) | Service ID 1 | ITS ch 1 | LTE rel-14 |
| Basic safety service 2 (electric emergency | Service ID 2 | ITS ch 1 | LTE rel-14 |
| brake light) | | | |
| . . . | . . . | | |
| Advanced use case 1 (autonomous driving) | Service ID 11 | ITS ch 6 | NR rel-16 |
| Advanced use case 2 (extended sensor | Service ID 12 | ITS ch 6 | NR rel-16 |
| sharing) | | | |
| Advanced use case 3 (platooning - group | Service ID 13 | ITS ch 4 | LTE rel-15 |
| join) | | | |

FIG. 5D illustrates an example of using an ITS frequency channel according to various embodiments.

According to the embodiment of [Table 4], frequency channel information as well as the sidelink RAT for V2X packet transmission/reception in the V2X use case may be configured. Although the sidelink protocol version information is described as the sidelink RAT information in the embodiment of [Table 4], the LTE sidelink and the NR sidelink may be configured.

For example, each of the use cases corresponding to the basic safety service and the advanced service may be indicated by a service ID, and sidelink protocol version information for V2X packet transmission/reception corresponding to the service ID may be configured. Here, frequency channel information to be used for the sidelink may be further configured, and the frequency corresponds to a frequency for ITS public service or a frequency for ITS service of MNO. According to the embodiments of [Table 4] and FIG. 5D, the ITS frequency may include 7 channels, two left channels may be configured to be used for the basic safety use case, and the remaining five channels may be configured to be used for the advanced use case.

According to the embodiment of [Table 4] above, the use case for the basic safety service may be configured to select LTE sidelink protocol version 14 and to use ITS frequency channel no. 1. The use case for the advanced service may be configured to select LTE sidelink protocol version 15 and NR sidelink protocol version 16 depending on the QoS requirement level. According to the embodiment of [Table 4] above, the QoS level required by advanced use case 2 (extended sensor sharing) is more stringent and thus is configured to select NR sidelink protocol version 16. At this time, it may be configured to be used for ITS frequency channel no. 6. The QoS level required by advanced use case 3 (platooning group join) is less stringent and thus is configured to select LTE sidelink protocol version 15. At this time, it may be configured to be used for ITS frequency channel no. 4.

As described in the embodiment of [Table 4], if the ITS frequency channel information is not separately configured unlike the case in which the ITS frequency channel information to use the selected sidelink RAT is also configured, the UE may randomly select channel no. 1 and channel no. 2 for the basic safety use case to transmit and receive a V2X packet using the selected sidelink RAT, and may randomly select channel no. 3 to channel no. 7 for the advanced use case to transmit and receive a V2X packet using the selected sidelink RAT.

[Table 5] to [Table 7] below show another embodiment of sidelink RAT configuration for each use case for V2X service.

TABLE 5

SST (slice and service type)
Transmission mode (broadcast/groupcast/unicast)
Interface (Uu/PC5)
. . .

TABLE 6

RAT
LTE
NR
LTE rel-14
LTE rel-15
NR rel-16
. . .

TABLE 7

TX profile
MCS (modulation coding scheme)
Rate matching
TBS scaling
SPS/configured grant
One-shot grant
. . .

In an embodiment of information which can be used when the sidelink RAT corresponding to the V2X use case is configured, mapping with a slice/service type (SST), a sidelink RAT, and TX profile may be used. The SST may indicate QoS requirements required by the V2X use case, a network function for supporting the corresponding use case, and protocol information.

The RAT may indicate a sidelink RAT or a sidelink RAT protocol version.

The TX profile may indicate QoS requirements required by the V2X use case, a radio function for supporting the corresponding use case, and configuration information.

For each V2X use case, the SST, the RAT, and the TX profile may be configured in advance. In order to meet the QoS requirements required in the V2X use case, a parameter combination of the SST, the RAT, and the TX profile may be used. The number of parameter combinations of the SST, the RAT, and the TX profile which can be applied to one V2X use case may be one or more. In this case, at least one of the radio condition and the UE capability may be further considered to determine the parameter combinations to be used for V2X packet transmission/reception.

According to various embodiments of the disclosure, entities for controlling sidelink RAT selection configuration information are described below.

(1) UE Determines Sidelink RAT by Itself

The UE may use sidelink RAT configuration information that is preconfigured in the UE. The sidelink RAT configuration information may include [Table 1] to [Table 5] above. A higher layer of the UE (application layer or a PC5 layer) may manage the sidelink RAT configuration information and select a sidelink RAT for transmitting a V2X packet generated on a V2X application layer on the basis of the use case of the V2X packet. The higher layer may indicate a sidelink RAT to be used for transmitting the corresponding V2X packet to a radio layer of the UE (AS layer).

(2) gNB or Ng-eNB Indicates Sidelink RAT

When the UE is in an RRC Connected state, the UE may receive sidelink RAT indication information from a service BS (gNB or ng-eNB). The gNB or the ng-eNB may determine a sidelink RAT with reference to at least one piece of service information based on the use case of the V2X packet transmitted by the UE, for example, a service ID mapped to the use case, a destination ID mapped to the use case, a group ID mapped to the use case, a bearer ID mapped to the use case, a flow ID mapped to the use case, a 5QI indicating packet QoS, a ProSe per-packet priority (PPPP) indicating a priority of the packet, and a ProSe per-packet reliability (PPPR) indicating a required reliability of the packet, and instruct the UE to use the determined sidelink RAT.

(3) Group Lead UE Indicates Sidelink RAT in Groupcast

The group lead UE may configure a sidelink RAT for the V2X use case to be managed by a group and indicate the configured sidelink RAT to group member UEs. Information required by the group lead UE to configure the sidelink RAT may include at least one piece of the following information. The information corresponds to service information based on the use case of the V2X packet, for example, a service ID mapped to the use case, a destination ID mapped to the use case, a group ID mapped to the use case, a bearer ID mapped to the use case, a flow ID mapped to the use case, a 5QI indicating packet QoS, a PPPP indicating a priority of the packet, and a PPPR indicating a required reliability of the packet.

(4) Transmission UE Indicates Sidelink RAT in Groupcast

For the unicast session required for packet transmission/reception in the V2X use case, the transmission UE may determine the sidelink RAT. The transmission UE may inform a counterpart reception UE of the selected sidelink RAT. Information required by the unicast transmission UE to configure the sidelink RAT may include one piece of the following information. The information corresponds to service information based on the use case of the V2X packet, for example, a service ID mapped to the use case, a destination ID mapped to the use case, a group ID mapped to the use case, a bearer ID mapped to the use case, a flow ID mapped to the use case, a 5QI indicating packet QoS, a PPPP indicating a priority of the packet, and a PPPR indicating a required reliability of the packet.

According to various embodiments of the disclosure, a reference for selecting the sidelink RAT is described below.

A UE (a UE, a group lead, or a transmission UE in a unicast session for selecting sidelink resources) and a network may select the sidelink RAT configured for each V2X use case on the basis of the information in [Table 1] to [Table 5]. As shown in [Table 4] above, the frequency channel information to use the sidelink RAT may include the case in which an ITS-dedicated band (for example, 5.9 GHz) is used or an MNO band (for example, 3.5 GHz) is used. When the sidelink RAT is used in the ITS-dedicated band, the preset configuration information shown in [Table 4] may be applied. When the sidelink RAT is used in the MNO band, the sidelink RAT may be used in a frequency channel indicated by the BS, the group lead UE, or the transmission UE in the unicast session. If the BS, the group lead UE, or the transmission UE in the unicast session does not separately indicate frequency channel information in the MNO band, the preset mapping information shown in [Table 4] may be used.

According to various embodiments of the disclosure, sidelink RAT selection configuration information is acquired as follows.

When a V2X packet is generated on the application layer of the UE, the UE may determine sidelink RAT information on the basis of service information based on the use case of the packet with reference to the configuration information in [Table 1] to [Table 5].

When the UE performs signaling of transmitting V2X service information on the UE to the BS (gNB/ng-eNB) or when the UE performs signaling of making a request for a sidelink grant for V2X packet transmission to the BS, the UE may acquire sidelink RAT selection information from the BS. An embodiment of signaling used by the UE may include a UEAssistanceInformation message and a SidelinkUEInformation message, and an embodiment of signaling used for acquiring sidelink RAT selection information may include an RRCConnectionReconfiguration message and a system information message of a unicast or broadcast scheme.

When the V2X packet is transmitted and received through group communication, sidelink RAT information may be configured in the case in which a group for the corresponding V2X use case may be formed (group formation signaling), a member may be joined in the group for the corresponding V2X use case (group join signaling), a V2X packet may be generated for the corresponding V2X use case, or resource information for transmitting a V2X packet for the corresponding V2X use case is acquired.

When the V2X packet is transmitted and received through unicast communication, sidelink RAT information may be configured in the case in which a unicast session is established for the corresponding V2X use case (unicast session establishment signaling), a V2X packet is generated for the corresponding V2X use case, or resource information for transmitting a V2X packet for the corresponding V2X use case is acquired.

An embodiment of parameters used for making a request for or configuring the sidelink RAT included in SidelinkUEInformation message, the UEAssistanceInformation message, the RRCConnectionReconfiguration message, the signaling for V2X group management (for example, group formation messages), and the signaling for V2X unicast session management (for example, unicast session establishment messages) is described below:

At least one piece of information such as a use case indicator, a service ID, a destination ID, a group ID, a QoS indicator, a UE RAT capability, a service flow ID, a bearer ID, a 5QI, a PPPP, and a PPPR

At least one piece of information such as a sidelink RAT indicator (sidelink RAT type or sidelink RAT protocol release), a frequency channel number, a TX profile, and a sidelink transmission scheme (unicast, broadcast, or groupcast).

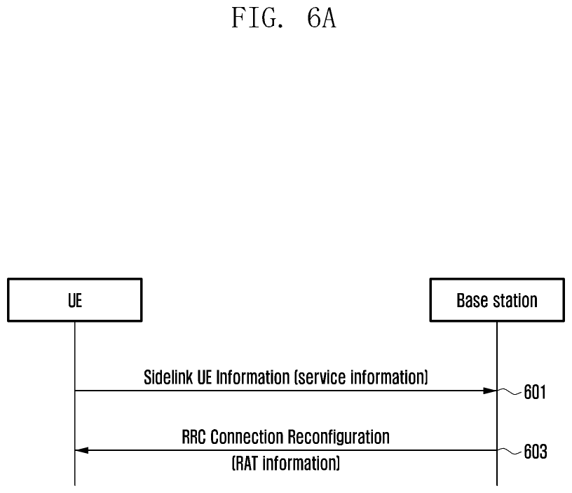

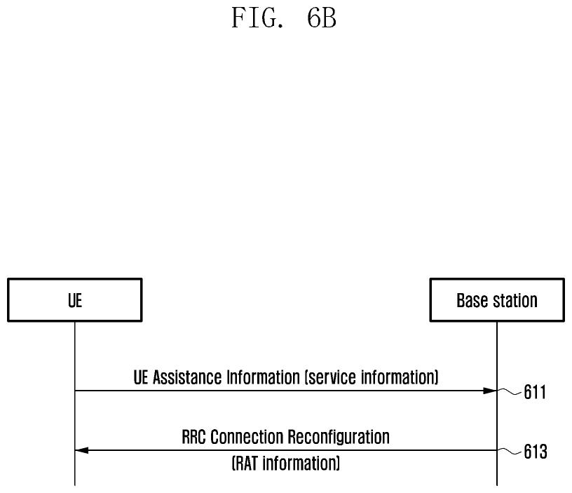

FIGS. 6A and 6B illustrate procedures between a UE and a BS for configuring a sidelink RAT for direct communication between UEs according to various embodiments of the disclosure.

FIG. 6A illustrates a procedure using SidelinkUEInformation signaling exchange.

The UE may transmit a first message including information required for selecting a sidelink RAT according to an embodiment of the disclosure while transmitting V2X service information to the BS in step 601. The first message may be a SidelinkUEInformation message. The BS may configure a sidelink RAT to be used by the UE for direct communication on the basis of information on the UE and transmit a second message including the configured sidelink RAT in step 603. The second message may be an RRCConnectionReconfiguration message.

The first message according to the embodiment of the disclosure may include at least one of the following parameters:

At least one piece of information such as a use case indicator, a service ID, a destination ID, a group ID, unicast information, a QoS indicator, a UE RAT capability, a service flow ID, a bearer ID, a 5QI, a PPPP, and a PPPR

SidelinkUEInformation ::= SEQUENCE {

| | |
|---|---|
| v2x-CommRxInterestedFreqList | SL-V2X-CommFreqList, |

| | |
|---|---|
| p2x-CommTxType-r14 | ENUMERATED {true}, |

v2x-CommTxResourceReq SL-V2X-CommTxFreqList,

| | |
|---|---|
| carrierFreq | ARFCN-Value, |

| | |
|---|---|
| priorityInfoListSL | PPPP_information, |
| reliabilityInfoListSL | PPPR_information, |
| QoSInfoListSL | 5QI_information, |
| serviceInfoListSL | DST_ID, // service ID, flow ID, bearer |
| | ID |
| groupInfoListSL | group_information, //group ID |
| unicastInfoListSL | unicast_information, //unicast session |
| | ID |

...
}

FIG. 6B illustrates a procedure using UEAssistanceInformation signaling exchange.

The UE may transmit a first message including information required for selecting a sidelink RAT according to an embodiment of the disclosure while transmitting V2X service information to the BS in step 611. The first message may be a UEAssistanceInformation message. The BS may configure a sidelink RAT to be used by the UE for direct communication on the basis of information on the UE and transmit a second message including the configured sidelink RAT in step 613. The second message may be an RRCConnectionReconfiguration message.

The first message according to the embodiment of the disclosure may include at least one of the following parameters:

At least one piece of information such as a use case indicator, a service ID, a destination ID, a group ID, unicast information, a QoS indicator, a UE RAT capability, a service flow ID, a bearer ID, a 5QI, a PPPP, and a PPPR

UEAssistanceInformation-IEs ::= SEQUENCE {
sps-AssistanceInformation SEQUENCE { //used as configuration information as

configured grant type 1 or configured grant type 2 in another embodiment

| | |
|---|---|
| trafficPeriodicity | trafficPeriodicity, |

| trafficDestination DST_ID, // service ID, flow ID, bearer ID | |
|---|---|
| priorityInfoListSL | PPPP_information, //PPPP index |
| reliabilityInfoListSL | PPPR_information, //PPPR index |
| QoSInfoListSL | 5QI_information |
| groupInfoListSL | group_information, //group ID |
| unicastInfoListSL | unicast_information, //unicast session ID |

| | |
|---|---|
| timingOffset | INTEGER (0.. 10239), |

| | |
|---|---|
| logicalChannelIdentityUL | INTEGER (3..31), |
| messageSize | BIT STRING (SIZE (6)) |

},
...
}

An embodiment of trafficPeriodicity may include:

sym2, sym7, sym1×14, sym2×14, sym4×14, sym5×14, sym8×14, sym10×14, sym16×14, sym20×14, sym32×14, sym40×14, sym64×14, sym80×14, sym128×14, sym160×14, sym256×14, sym320×14, sym512×14, sym640×14, sym1024×14, sym1280×14, sym2560×14, sym5120×14, sym6, sym1×12, sym2×12, sym4×12, sym5×12, sym8×12, sym10×12, sym16×12, sym20×12, sym32×12, sym40×12, sym64×12, sym80×12, sym128×12, sym160×12, sym256×12, sym320×12, sym512×12, sym640×12, sym1280×12, sym2560×12

In the embodiment of FIGS. 6A and 6B, information included in the second message used for transmitting sidelink RAT configuration information to the UE may include at least one of the following parameters:

At least one piece of information such as a sidelink RAT indicator (sidelink RAT type or sidelink RAT protocol release), a frequency channel number, a TX profile, and a sidelink transmission scheme (unicast, broadcast, or groupcast).

| RRCConnectionReconfiguration message | | |
|---|---|---|
| SL-CommRATListV2X ::= SEQUENCE { | | |
| trafficDestination DST_ID, // service ID, flow ID, bearer ID | | |
| groupInfoListSL | group_information, // group ID | |
| unicastInfoListSL | unicast_information, | //unicast session ID |

| rat_SL | RAT_type, // LTE SL, NR SL, protocol release | |
|---|---|---|
| freq_SL | Freq_channel, // frequency channel index | |
| tx_profile_SL | TX_profile, | // radio configuration |

| transmission_type_SL TX_type, // unicast, groupcast, broadcast | |
|---|---|
| sl_V2X_ResourceconfigInfo | SL-V2X-ResourceconfigInfo, //sidelink resource |

pool

| ... | |
|---|---|
| } | |
| SL-V2X-ResourceconfigInfo ::= | SEQUENCE { |

v2x-GroupRxPoolList,
v2x-GroupTxPoolList,
v2x-UnicastRxPoolList,
v2x-UnicastTxPoolList,
v2x-CommRxPoolList,
v2x-CommTxPoolList,
...
}

If a GroupRxPoolList and a GroupTxPoolList are configured, resource pool information for groupcast V2X packet transmission and reception may be included. In this case, the UE may transmit and receive the V2X packet for groupcast through the resource pool.

If a UnicastRxPoolList and a UnicastTxPoolList are configured, resource pool information for unicast V2X packet transmission and reception may be included. In this case, the UE may transmit and receive the V2X packet for unicast through the resource pool.

If a CommRxPoolList and a CommTxPoolList are configured, resource pool information for broadcast V2X packet transmission and reception may be included. In this case, the UE may transmit and receive the V2X packet for broadcast through the resource pool.

If the GroupRxPoolList, the GroupTxPoolList, the UnicastRxPoolList, and the UnicastTxPoolList are not configured, the UE may transmit and receive the V2X packet for unicast, groupcast, and broadcast on the basis of resource pool information configured in the CommRxPoolList and CommTxPoolList.

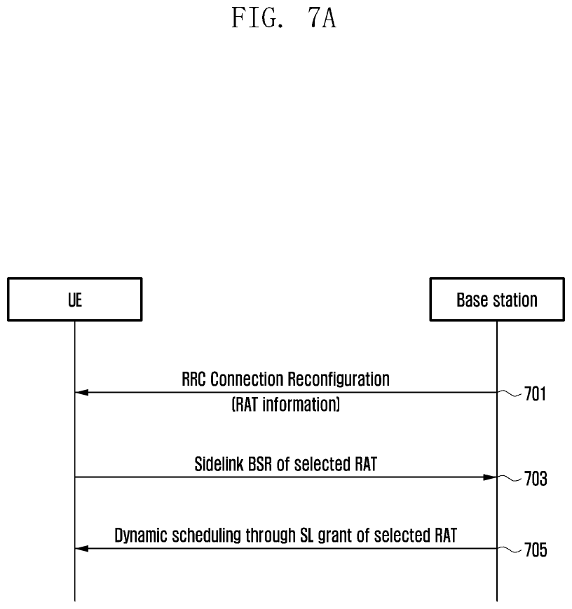

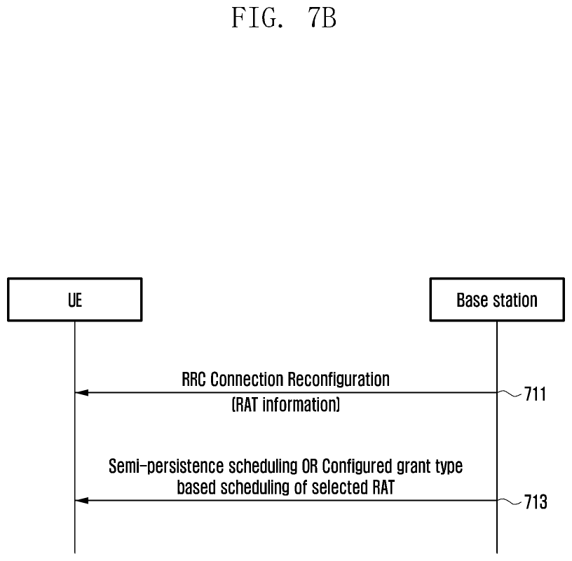

FIGS. 7A and 7B illustrate signal procedures between a BS and a UE acquiring sidelink resource allocation information on the basis of configured sidelink RAT information according to various embodiments of the disclosure. A signal procedure for configuring sidelink RAT information follows the embodiment of FIGS. 6A and 6B.

FIG. 7A illustrates an embodiment of dynamically receiving a configuration of sidelink RAT resources.

The UE may receive a message including sidelink RAT configuration information from the BS in step 701. The message may be an RRCConnectionReconfiguration message. The message received in step 701 may include sidelink RAT configuration information and dynamic resource allocation information. The UE may transmit sidelink buffer status report (BSR) signaling for receiving dynamic allocation of the configured sidelink RAT resources to the BS according to the sidelink RAT configuration and dynamic resource allocation information. For example, if the sidelink RAT indicates an LTE sidelink, the UE may transmit an LTE sidelink BSR to the BS. In another example, if the sidelink RAT indicates an NR sidelink, the UE may transmit an NR sidelink BSR to the BS. The BS may dynamically allocate resources to be used by the UE to transmit a V2X packet in the configured sidelink RAT on the basis of information on the sidelink BSR signaling transmitted by the UE in step 705.

FIG. 7B illustrates an embodiment of receiving allocation of sidelink RAT resources through a method such as an SPS, configured grant type 1, or configured grant type 2.

The UE may receive a message including sidelink RAT configuration information from the BS in step 711. The message may be an RRCConnectionReconfiguration message. The message received in step 711 may include at least one piece of sidelink RAT configuration information, and SRS-based resource allocation information, configured grant type 1-based resource allocation information, or configured grant type 2-based resource allocation information. The UE may receive allocation of the configured sidelink RAT resources from the BS on the basis of the SPS, configured grant type 1, or configured grant type 2 according to the sidelink RAT configuration and sidelink resource allocation information in step 713. For example, if the sidelink RAT indicates an LTE sidelink, the UE may receive LTE-sidelink SPS-based resource allocation information and transmit a V2X packet through the allocated resources. In another example, if the sidelink RAT indicates an NR sidelink, the UE may receive NR sidelink SPS-based resource allocation information, NR sidelink configured grant type 1-based resource allocation information, or NR sidelink configured grant type 2-based resource allocation information, and transmit a V2X packet through the allocated resources.

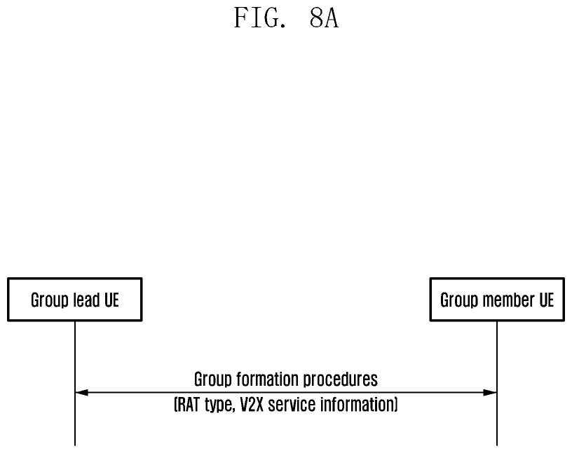

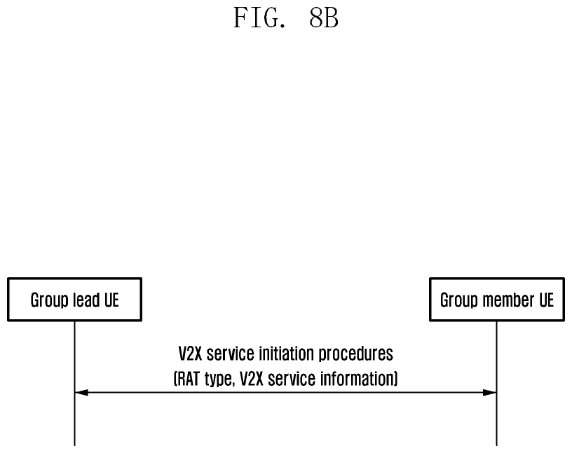

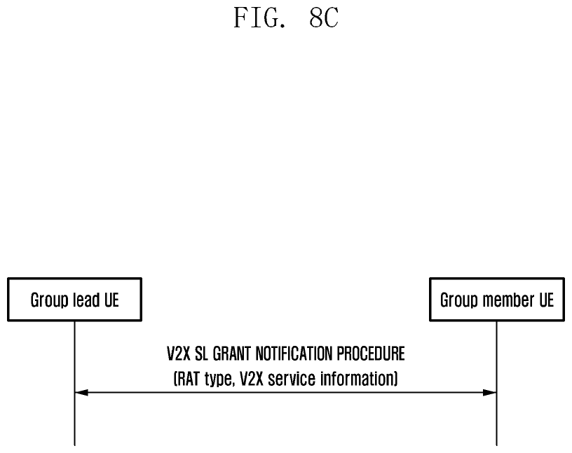

FIGS. 8A and 8B illustrate signal procedures between UEs exchanging sidelink RAT configuration information for groupcast according to various embodiments of the disclosure.

FIG. 8A illustrates a signal procedure between UEs exchanging V2X service information including sidelink RAT configuration information to be used for V2X packet transmission/reception for the V2X use case in a process of forming a group for V2X packet transmission/reception of the V2X use case or joining in the group.

Referring to FIG. 8A, a group member UE may perform a procedure of forming a V2X group corresponding to the V2X use case or joining in the V2X group through signaling with a group lead UE. The group member UE and the group lead UE may exchange capability information required for configuring the V2X sidelink RAT. The group member UE may receive sidelink RAT configuration information for the V2X use case, which is used by the V2X group, from the group lead UE. The group lead UE may transmit a V2X use case list to be managed by the V2X group and sidelink RAT information to be used for V2X packet transmission/reception in the V2X use case. The group lead UE may transmit frequency channel information to be used for V2X packet transmission/reception in the V2X use case of the V2X group. The group lead UE may transmit interface information indicating whether to use a Uu interface or a sidelink interface for V2X packet transmission/reception in the V2X use case of the V2X group.

FIG. 8B illustrates a signal procedure between UEs exchanging V2X service information including sidelink RAT configuration information to be used for V2X packet transmission/reception in the V2X use case in a process of informing of starting of the V2X service for the V2X use case using a groupcast scheme. The process of informing of starting of the V2X service may correspond to, for example, a procedure of informing group members of starting of V2X packet transmission/reception in the V2X use case.

The group member UE may receive sidelink RAT configuration information for the V2X use case starting the service, from the group lead UE. The group lead UE may transmit a V2X use case list corresponding to the started V2X service and sidelink RAT information to be used for V2X packet transmission/reception in the V2X use case. The group lead UE may transmit frequency channel information to be used for V2X packet transmission/reception in the V2X use case of the V2X group. The group lead UE may transmit interface information indicating whether to use a Uu interface or a sidelink interface for V2X packet transmission/reception in the V2X use case.

FIG. 8C illustrates a signal procedure between UEs exchanging V2X service information including sidelink RAT configuration information to be used for V2X packet transmission/reception in the V2X use case in a process of acquiring SL grant information to be used for V2X packet transmission/reception in the V2X use case using a groupcast scheme.

The group member UE may receive sidelink RAT configuration information on an SL grant to be used for transmitting and receiving a V2X packet from the group lead UE. The sidelink RAT configuration information on the SL grant may include SL grant information for transmitting the V2 X packet. The group lead UE may transmit frequency channel information to be used for V2X packet transmission/reception in the V2X use case of the V2X group. The V2X service information acquired by the group member UE may include at least one piece of a V2X use case list, sidelink RAT configuration information for the V2X use case, SL grant information, and frequency channel information when the number of V2X use cases is one or more.

According to an embodiment of the disclosure, a method of informing of the SL grant information for groupcast is described below.

(1) The case in which the BS schedules sidelink resources for V2X packet transmission/reception for groupcast or the UE directly selects the sidelink resources may be considered.

(2) A method of receiving implicit allocation of sidelink resources without informing of whether the sidelink resources are for groupcast and a method of receiving explicit allocation thereof may be considered.

(3) In the implicit method, a group member UE to transmit a V2X packet may select sidelink resources by itself or may receive allocation of sidelink resources through scheduling of the BS. Meanwhile, sidelink RAT information for allocating sidelink resources may be determined by itself on the basis of mapping information in [Table 1] to [Table 5] or may be indicated by the group lead UE or the BS. The group member UE may determine an RAT for performing an SL grant according to the configured sidelink RAT information. For example, if it is determined to use an LTE sidelink, an LTE SL BSR may be used. For example, when it is determined to use an NR sidelink, NR SL BSR may be used.

(4) In the explicit method, the group lead UE may be involved in a process of allocating sidelink resources for groupcast. The group lead UE may select sidelink resources for the V2X use case for groupcast by itself and transmit the selected sidelink resources to the group member UE to which the V2X packet is transmitted. The group lead UE may receive allocation of sidelink resources for the V2X use case for groupcast from the BS and transmit the allocated sidelink resources to the group member UE to which the V2X packet is transmitted.

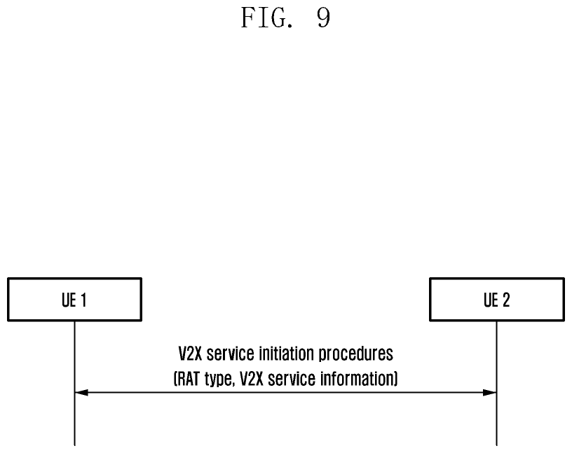

FIG. 9 illustrates a signal procedure between UEs exchanging sidelink RAT configuration information for unicast according to various embodiments of the disclosure. Referring to FIG. 9, when a service for the V2X use case starts between two UEs in which a unicast session is configured, for example, when packet transmission/reception in the V2X use case starts, UE1 may select sidelink RAT to be used for packet transmission/reception in the V2X use case and transmit the sidelink RAT information and V2X service configuration information to the reception UE. In order to select the sidelink RAT, the two UEs in which the unicast session is configured may exchange RAT capability information. UE1 may use the services and RAT configuration information in [Table 1] to [Table 5] to select the sidelink RAT to be used for packet transmission/reception in the V2X use case. UE1 may use sidelink RAT configuration information to be used for packet transmission/reception in the V2X use case, acquired during a procedure of exchanging V2X service information with the BS with reference to the embodiments of FIGS. 6 and 7. UE1 may transmit the selected sidelink RAT configuration information to UE2. The sidelink RAT configuration information transmitted to UE2 may be the same as the information determined by UE1 or the information indicated by the BS. According to another embodiment, the sidelink RAT configuration information transmitted to UE2 may correspond to information determined through the exchange of the RAT capability with UE2 as well as the information determined by UE1. According to another embodiment, the sidelink RAT configuration information transmitted to UE2 may correspond to information determined through the exchange of the RAT capability with UE2 as well as the information indicated by the BS.

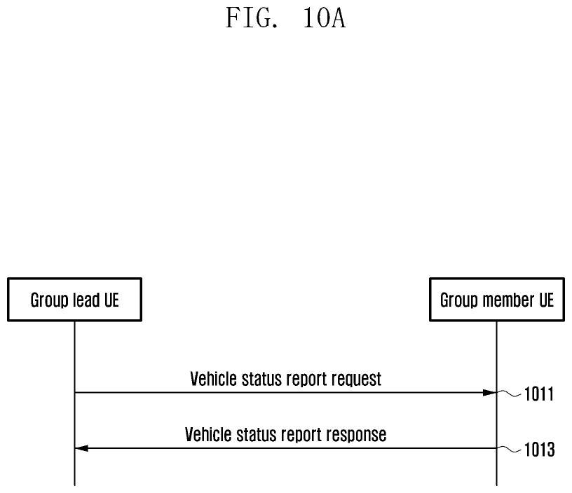

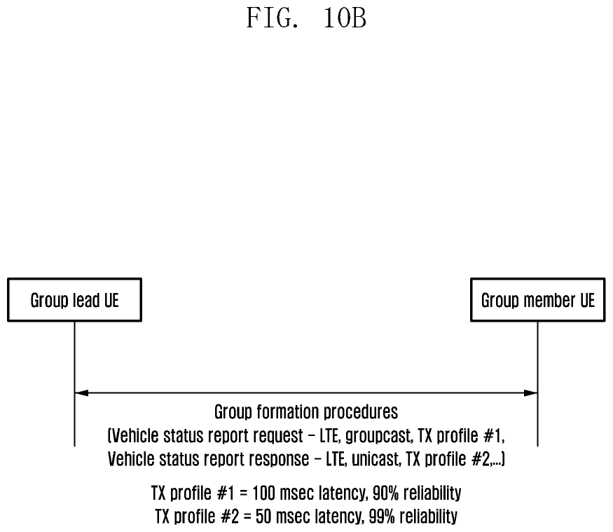

FIGS. 10A and 10B illustrate signal procedures between UEs exchanging sidelink RAT configuration information in a platooning scenario according to various embodiments of the disclosure. FIG. 10A illustrates an embodiment of exchanging vehicle status report information between a group lead UE and a group member UE in platooning. Referring to FIG. 10A, the group lead UE may transmit a request message to group member UEs in order to acquire vehicle status information on the group member UEs participating in platooning in step 1011. The request message may be a vehicle status report request. Upon receiving the request message, the group member UE may transmit a response message to the group lead UE in step 1013. The response message may be a vehicle status report response.

When sidelink RAT information for transmitting the request message and the vehicle status report is configured in step 1011 and step 1013, a transmission requirement of each message may be considered. The transmission requirement of each message is described below.

The vehicle status report request is transmitted from the group lead UE to group member UEs in a groupcast scheme, and should satisfy requirements such as 100 msec latency and 90% reliability. In order to transmit the vehicle status report request, an upper layer of the group lead UE may configure a vehicle status report request packet to have SST=groupcast, RAT=LTE, and TX profile=100 msec latency/90% reliability.

The vehicle status report response is transmitted from the group member to the group lead in a unicast scheme, and should satisfy requirements such as 50 msec latency and 99% reliability.

In order to transmit the vehicle status report response, an upper layer of the group member UE may configure a vehicle status report response packet to have SST=unicast, RAT=NR, and TX profile=50 msec latency/99% reliability.

As described in the embodiment, a method of configuring sidelink RAT information in consideration of the transmission requirements will be described with reference to FIG. 10B below.

FIG. 10B illustrates an embodiment of configuring a sidelink RAT for exchanging vehicle status report information in platooning. Referring to FIG. 10B, in groupcast control signaling exchanged between the group lead UE and the group member UE, sidelink RAT information for transmitting the request message and the response message of FIG. 10A may be exchanged. In the embodiment of FIG. 10B, it is assumed that the sidelink RAT information is exchanged in a group formation procedure. The group lead UE may transmit at least one piece of RAT information to be used for transmitting a vehicle status report request and a vehicle status report response, transmission mode information (groupcast, broadcast, and unicast), and TX profile information to the group member UE. The TX profile information may be preset to reflect transmission QoS requirements of the request message and the response message. According to another embodiment, the TX profile information is information which can be changed by reflecting a radio condition at a time point at which the request message and the response message are transmitted. When the TX profile is changed, the group lead UE may transmit the changed TX profile information to the group member UE.

In an embodiment of determining the RAT for transmitting the request message and the response message, the transmission mode, and the TX profile, the group lead UE may use a preset mapping table (for example, [Table 1] to [Table 5]). In another embodiment of determining the RAT, the transmission mode, and the TX profile, RAT information and TX profile information mapped to the service (or use case) may be exchanged using a group formation procedure, a service initiation procedure, or an SL grant procedure between the group lead UE and the group member UE. In another embodiment of determining the RAT, the transmission mode, and the TX profile, the information may be indicated to the group lead UE from the BS, and the group lead UE may transmit the determined RAT, transmission mode, and TX profile to the group member UE according to the indication of the BS.

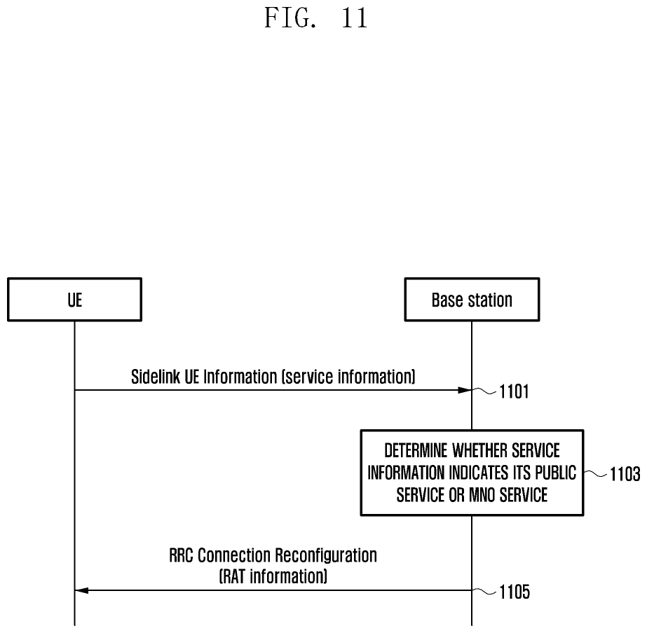

FIG. 11 illustrates a signal procedure between a BS and a UE exchanging sidelink RAT configuration information on the basis of an entity that manages an ITS service according to various embodiments of the disclosure. For example, the ITS service may be divided into an ITS public service and an MNO service according to the entity that manages the ITS service. The UE may acquire a sidelink RAT and ITS frequency channel information which can be used for the ITS public service. The UE may acquire a sidelink RAT and MNO frequency channel information which can be used for the MNO service.

Referring to FIG. 11, the UE may transmit V2X service information to the BS in step 1101. The V2X service information may be transmitted using a SidelinkUEInformation message or a UEAssistanceInformation message. The V2X service information may include, for example, service ID information indicating the V2X use case. The service ID may be separately managed for the ITS public service and the MNO service. The BS receiving the V2X service information on the UE may determine whether the V2X use case of the UE is the ITS public service or the MNO service on the basis of the service ID information in step 1103. When it is determined that the V2X use case is the MNO service, the BS may configure the sidelink RAT for the MNO service and configure frequency channel information. When it is determined that the V2X use case is the ITS public service, the BS may configure the sidelink RAT for the ITS public service and configure frequency channel information. The BS may transmit a message including at least one of the sidelink RAT and the frequency channel information configured in step 1103 to the UE in step 1105. The message may be an RRCConnectionReconfiguration message. The UE may transmit and receive a V2X packet for the service ID requested in step 1101 on the basis of at least one of the sidelink RAT and the frequency channel information configured in the message. When the separate sidelink RAT and frequency channel information are not received from the BS in step 1105, the UE may configure the sidelink RAT and the frequency channel using [Table 1] to [Table 5].

The methods of selecting the sidelink RAT used for transmitting and receiving the V2X service packet have been described with reference to the various embodiments.

Hereinafter, a method of selecting a sidelink RAT for transmitting signaling for the groupcast control to perform V2X groupcast communication and V2X unicast communication (for example, direct communication signaling used for group formation, direct communication signaling used for group join, and direct communication signaling used for the group control) and signaling for the unicast control (for example, direct communication signaling used for unicast session establishment and direct communication signaling used for unicast session management) will be described.

(1) Method Using Preset RAT

As an embodiment using a preset RAT, [Table 1] to [Table 5] may be used. For example, a service ID corresponding to signaling for the groupcast control may be configured, and sidelink RAT information for the service ID may be configured. In another example, the corresponding service ID may be configured for each purpose of the signaling for the groupcast control, and sidelink RAT information for the service ID may be configured. The unicast control signaling may be similarly applied.

As an embodiment using a preset RAT, a separate resource pool may be managed to be used for transmitting groupcast control signaling, and an RAT indicated by the separate resource pool may be used. The separate resource pool may be stored in the UE as a pre-configured resource pool. The separate resource pool may be a group specific-resource pool or unicast specific-resource pool, which is distinguished from a general resource pool. The unicast control signaling may be similarly applied.

An embodiment of managing the separate groupcast and unicast-specific resource pools is described below.

SL-V2X-ResourceconfigInfo ::= SEQUENCE {
v2x-GroupRxPoolList,
v2x-GroupTxPoolList,
v2x-UnicastRxPoolList,
v2x-UnicastTxPoolList,
v2x-CommRxPoolList,
v2x-CommTxPoolList,
...
}

A TX pool list and an RX pool list of the pre-configured sidelink resource pool information may include at least one piece of the sidelink RAT information and the resource pool information. According to an embodiment, a group TX pool list and a group RX pool list may be used for groupcast control signaling. A unicast RX pool list and a unicast TX pool list may be used for unicast control signaling. A comm TX pool list and a comm RX pool list may be used to transmit and receive a V2X packet. According to another embodiment, the group TX pool list and the group RX pool list may be used for groupcast control signaling and groupcast V2X packet transmission/reception. The unicast RX pool list and the unicast TX pool list may be used for unicast control signaling and unicast V2X packet transmission/reception. The comm TX pool list and the comm RX pool list may be used to transmit and receive a general V2X packet.

According to an embodiment of using the pre-configured RAT, an NR sidelink may be indicated to be always used.

According to an embodiment of using the pre-configured RAT, an LTE sidelink may be indicated to be always used.

According to an embodiment of using the pre-configured RAT, a sidelink RAT may be configured for each use case type used in groupcast and unicast. Groupcast control signaling or unicast control signaling for V2X packet transmission/reception in the advanced use case may be indicated to use the NR sidelink. Groupcast control signaling or unicast control signaling for V2X packet transmission/reception in the basic safety use case may be indicated to use the LTE sidelink.

According to an embodiment of using the pre-configured RAT, a sidelink RAT corresponding to an RAT of a serving BS (or a master BS) of the group lead UE may be indicated to be used in the groupcast. According to an embodiment of using the pre-configured RAT, a sidelink RAT corresponding to an RAT of a serving BS (or a master BS) of the transmission UE may be indicated to be used in the unicast.

(2) Method using RAT indicated by BS

According to an embodiment using an RAT indicated by the BS, a sidelink RAT for groupcast control signaling may be indicated by a serving BS (or a master BS) of the group lead UE in the groupcast. A sidelink RAT for unicast control signaling may be indicated by a serving BS (or a master BS) of the unicast transmission UE in the unicast. In the case of mixed configuration such as MR-DC, the master BS may indicate a sidelink RAT. In the case of mixed configuration such as MR-DC, the gNB may indicate a sidelink RAT. In the case of mixed configuration such as MR-DC, the ng-eNB may indicate a sidelink RAT.

For example, the BS may indicate sidelink RAT information for the groupcast control to the group lead UE through Uu signaling. If the use of the NR sidelink is indicated, the group lead UE may broadcast groupcast control signaling (for example, group formation initiation signaling) through the NR sidelink. If the use of the LTE sidelink is indicated, the group lead UE may broadcast groupcast control signaling (for example, group formation initiation signaling broadcast) through the LTE sidelink.

According to another embodiment, the BS may indicate sidelink RAT information for the groupcast control to the UE which is interested in the group through Uu signaling. The Uu signaling may use, for example, a SidelinkUEInformation message or a UEAssistanceInformation message. The UE may transmit an interested group ID on the basis of the SidelinkUEInformation and the UEAssistanceInformation. The BS receiving the interested group ID may transmit sidelink RAT information which can be used for signaling for controlling the interested group.

### Second Embodiment

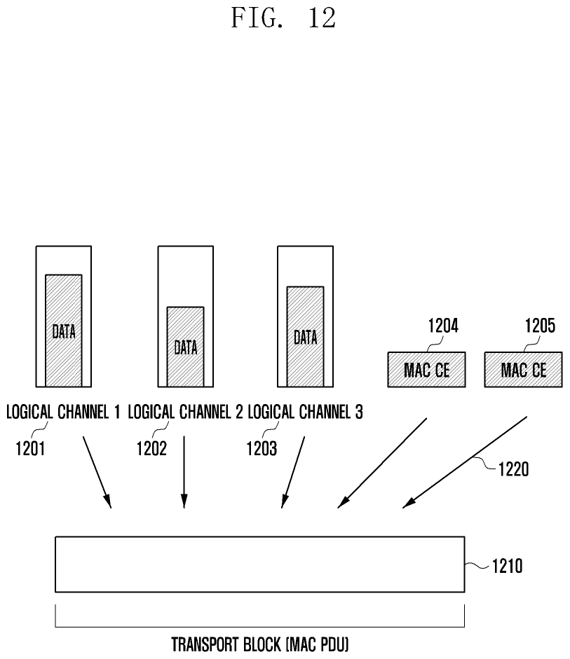

FIG. 12 illustrates an operation process in which the UE allocates a MAC control element (CE) and data to a MAC PDU. In the embodiment of FIG. 12, it is assumed that there are a total of three logical channels in which the UE is configured, such as logical channel #1 1201, logical channel #2 1202, and logical channel #3 1203, and two MAC CEs 1204 and 1205 according to one embodiment. When the UE receives allocation of a transport block (TB) 1210, the UE may receive allocation of a predetermined amount of radio resources according to priorities of each logical channel and the MAC CE and insert data of the logical channel and the MAC CE into a transport block in step 1220. The transport block is the term used by a physical layer and is referred to as a MAC protocol data unit (PDU) in the MAC layer. At this time, a process of allocating radio resources of the MAC PDU to a plurality of logical channels is referred to as logical channel prioritization (LCP). The operation process of allocating the MAC CE and the data to the MAC PDU corresponds to multiplexing, and the logical channel prioritization process is a portion of the multiplexing operation.

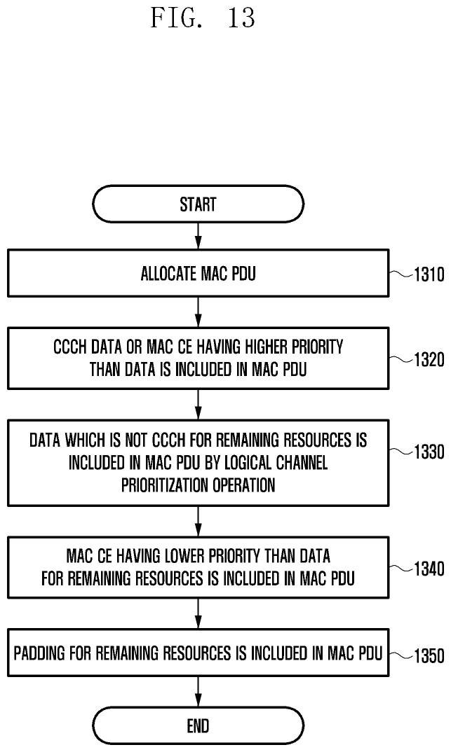

FIG. 13 illustrates a detailed operation process in which the UE allocates a MAC control element (CE) and data to a MAC PDU. The UE may receive allocation of the MAC PDU in step 1310. Thereafter, common control channel (CCCH) data or a MAC CE having a higher priority than data, which is not the CCCH, is first inserted into the MAC PDU in step 1320. At this time, if resources of the allocated MAC PDU are not large enough to include CCCH data or the MAC CE, the corresponding CCCH data or the MAC CE cannot be included. If there is no CCCH data or no MAC CE having a higher priority than data, which is not the CCCH, the corresponding CCCH data or the MAC CE may not be included. The MAC CE having a higher priority than data, which is not the CCCH, may be a C-RNTI MAC CE, a configured grant confirmation MAC CE, a buffer status report (BSR), which is not padding, a single entry power headroom report (PHR), or a multiple entry power headroom report (PHR).

If there are remaining resources which have not been allocated after step 1320, data which is not the CCCH may be inserted into the MAC PDU for the remaining resources according to a logical channel prioritization operation. When the corresponding logical channel is configured for the logical channel prioritization process, relevant parameters may be received from the BS through an RRC message. The corresponding parameters may be a prioritized bit rate (PBR), bucket size duration (BSD), and a priority. The UE may update a Bj value, which should be processed per logical channel (data, which should be processed for a logical channel j), by using the parameters. The Bj value may be used in a first step of the logical channel prioritization process, and the UE may allocate resources to logical channels having a Bj value larger than 0 according to priorities thereof in the first step of the logical channel prioritization. Furthermore, the Bj value is reduced by allocated resources. If there are remaining resources after the first step, the resources may be allocated such that all the remaining data of respective logical channels is transmitted according to priorities of the logical channels regardless of the Bj value in a second step of the logical channel prioritization.

If there are remaining resources, which have not been allocated, after step 1330, a MAC CE having a lower priority than the data for the remaining resources may be inserted into the MAC PDU in step 1340. At this time, if resources of the allocated MAC PDU are not large enough to include all of the corresponding MAC CE, the corresponding MAC CE cannot be included. Also, when the corresponding MAC CE does not exist, the corresponding MAC CE cannot be included. The MAC CE having a lower priority than data may be a recommended bit rate (RBR) query MAC CE or a padding BSR MAC CE. If there are remaining resources, which have not been allocated, after step 1340, padding for the remaining resources may be inserted into the MAC PDU in step 1350.

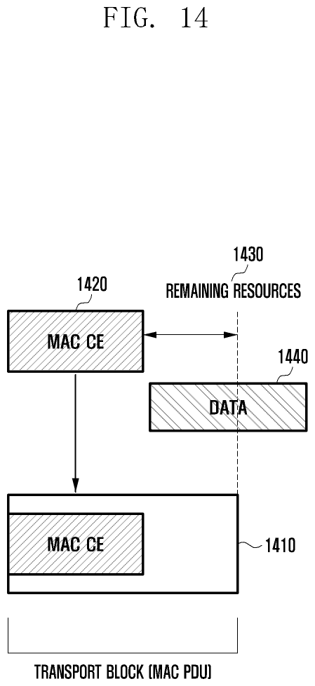

FIG. 14 illustrates an example in which a data transmission delay is generated by a MAC CE having a higher priority than data. As illustrated in FIG. 13, some MAC CEs have a higher priority than the data, which is not the CCCH, and thus have a priority to use a MAC PDU 1410 regardless of a data priority. The MAC CE 1420 may be a C-RNTI MAC CE, a configured grant confirmation MAC CE, a buffer status report (BSR) which is not padding, or a single entry power headroom report (PHR). If the allocated MAC PDU is resources for ultra reliable and low latency communication (URLLC), the size of the allocated MAC PDU is large enough to process the corresponding data, and another MAC CE 1420 having a high priority is first allocated, the size of remaining resources 1430 is smaller than the size of the data, and thus the data cannot be transmitted or is segmented to be separately transmitted through the corresponding resources and other resources as indicated by reference numeral 1440. Accordingly, a time at which entire data reaches a receiver may be delayed. Therefore, service requirements may not be satisfied due to the data transmission delay. Particularly, in the case of service having stringent delay time requirements such as URLLC, the delay time may deteriorate the overall performance, thereby generating a serious problem.

In order to solve the problem, even a MAC CE having a high priority may not receive allocation of resources in spite of a priority higher than specific data. Alternatively, according to some embodiments, in the case of predetermined radio resources, a MAC CE may not be included or may have a lower priority than data. Whether the MAC CE is not included in a MAC PDU or a transport block or the MAC CE has a lower priority than data may be configured in advance, configured by RRC, or indicated by DCI internal information when radio resources are configured.

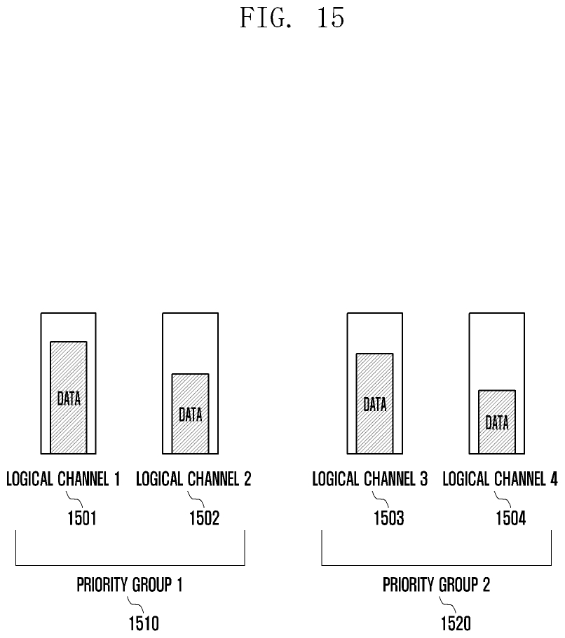

FIG. 15 illustrates a method of configuring priority groups of logical channels proposed in the disclosure. As illustrated in FIGS. 13 and 14, a logical channel for processing data has a lower priority than some MAC CEs and thus, if the corresponding MAC CEs are generated, data transmission is delayed and the performance deteriorates. In order to solve the problem, the disclosure proposes a method of designating priority groups of the logical channels and giving relatively different priorities to the priority groups with respect to the MAC CE. In the embodiment of FIG. 15, it is assumed that four logical channels 1501, 1502, 1503, and 1504 are configured. Logical channel #1 1501 and logical channel #2 1502 are classified as priority group #1 1510 since they are logical channels which need to have a higher priority than some MAC CEs, and logical channel #3 1503 and logical channel #4 1504 are classified as priority group #2 1520 since they are logical channels which may have a general priority. The term “priority” is a general priority for first processing rather than a priority value assigned in each logical channel configuration.

When the two priority groups are divided, each priority group has the following characteristics:
Priority group 1: is processed to have a lower priority than CCCH data or some MAC CEs that require a very high priority but is processed to have a higher priority than a MAC CE that requires a medium priority, a MAC CE that requires a low priority, and data in priority group 2.
Priority group 2: is processed to have a lower priority than CCCH data or some MAC CEs that require a very high priority, data in priority group 1, and a MAC CE that requires a medium priority but is processed to have a higher priority than other MAC CEs that require a low priority.

In some embodiments, the order applied in the logical channel prioritization process is described below (in order of priority from the highest priority):
C-RNTI MAC CE or UL-CCCH data
Configured grant confirmation MAC CE
Logical channel data in priority group 1
BSR MAC CE which is not padding BSR
Single entry PHR or multiple entry PHR MAC CE
Logical channel data in priority group 2
Recommended bit rate query MAC CE
Padding BSR

However, the order does not necessarily have to be the same as the example, and each priority group only needs to have a separate prioritization order.

A method of separating priority groups for respective logical channels may be determined by at least one of the following methods:
A priority group is configured when a logical channel is configured.
A logical channel which can use configured grant type 1 is configured as priority group 1. The remaining logical channels are priority group 2.
A logical channel which can use specific subcarrier spacing is configured as priority group 1. The remaining logical channels are priority group 2.
A logical channel having a specific logical channel ID is configured as priority group 1. The remaining logical channels are priority group 2 (for example, LCIDs 25-32 are priority group 1).
A logical channel which can use radio resources allocated by an MCS-C-RNTI is configured as priority group 1. The remaining logical channels are priority group 2.
A logical channel having a limitless prioritized bit rate (PBR) value is configured as priority group 1. The remaining logical channels are priority group 2.
A logical channel having a specific value as a priority value for the logical channel is configured as priority group 1. The remaining logical channels are priority group 2.
A logical channel having a priority value for the logical channel smaller than a predetermined threshold value for the logical channel is configured as priority group 1. The remaining logical channels are priority group 2 (it may be assumed that a lower priority value has a higher priority. For example, if it is assumed that a threshold value is 2, a logical channel having a priority value of 1 is configured as priority group 1 and a logical channel having a priority value of 3 is configured as priority group 2).

Various methods as well as the above method may be used to designate a priority group of a logical channel.

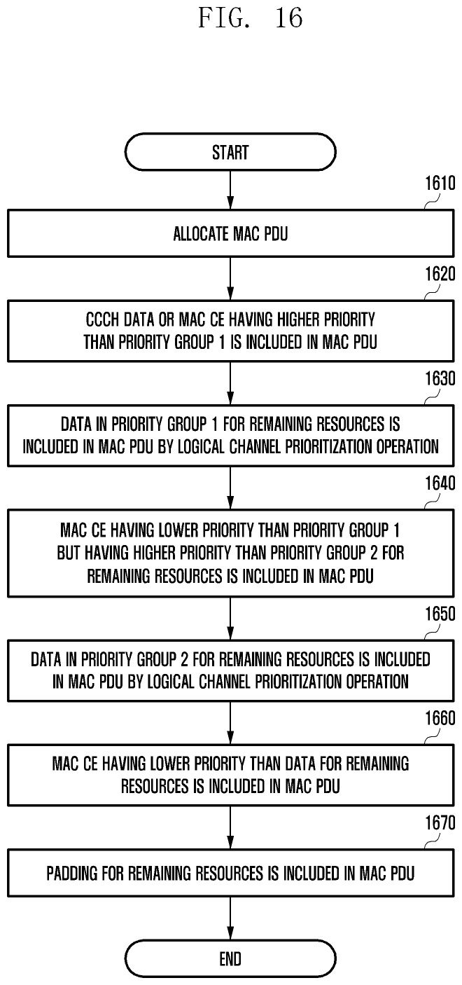

FIG. 16 illustrates a logical channel prioritization method according to a priority group configuration proposed in the disclosure. The embodiment of FIG. 16 may be a detailed operation of the embodiment in which there are two priority groups as illustrated in FIG. 15. The UE may receive allocation of the MAC PDU in step 1610. Thereafter, CCCH data or a MAC CE having a higher priority than data in priority group 1, which is not the CCCH, is inserted into a MAC PDU in step 1620. At this time, if resources of the allocated MAC PDU are not large enough to include CCCH data or the MAC CE, the corresponding CCCH data or the MAC CE cannot be included. If there is no CCCH data or no MAC CE having a higher priority than data in priority group 1, which is not the CCCH, the corresponding CCCH data or the MAC CE may be included. The MAC CE having a higher priority than data in priority group 1, which is not the CCCH, may be a C-RNTI MAC CE or a configured grant confirmation MAC CE.

If there are remaining resources, which have not been allocated, after step 1620, data in priority group 1, which is not the CCCH, may be inserted into the MAC PDU for the remaining resources according to the logical channel prioritization operation in step 1630. When the corresponding logical channel is configured for the logical channel prioritization process, relevant parameters may be received from the BS through an RRC message. The corresponding parameters may be a prioritized bit rate (PBR), bucket size duration (BSD), and a priority. The UE may update a Bj value, which should be processed per logical channel (data, which should be processed for a logical channel j), by using the parameters. The Bj value may be used in a first step of the logical channel prioritization process, and the UE may allocate resources to logical channels in priority group 1 having a Bj value larger than 0 according to priorities thereof in the first step of the logical channel prioritization. Furthermore, the Bj value is reduced by allocated resources. If there are remaining resources after the first step, the resources may be allocated such that all the remaining data of respective logical channels is transmitted according to priorities of the logical channels in priority group 1 regardless of the Bj value in a second step of the logical channel prioritization.

If there are remaining resources, which have not been allocated, after step 1630, a MAC CE having a lower priority than priority group 1 but a higher priority than priority group 2 for the remaining resources may be included in into the MAC PDU in step 1640. At this time, if resources of the allocated MAC PDU are not large enough to include all of the corresponding MAC CE, the corresponding MAC CE cannot be included. Also, when the corresponding MAC CE does not exist, the corresponding MAC CE cannot be included. The MAC CE having a lower priority than priority group 1 but a higher priority than priority group 2 may be a buffer status report (BSR) which is not padding, a single entry power headroom report (PHR), or a multiple entry PHR.

If there are remaining resources, which have not been allocated, after step 1640, data in priority group 2, which is not the CCCH, may be inserted into the MAC PDU for the remaining resources according to the logical channel prioritization operation in step 1650. When the corresponding logical channel is configured for the logical channel prioritization process, relevant parameters may be received from the BS through an RRC message. The corresponding parameters may be a prioritized bit rate (PBR), bucket size duration (BSD), and a priority. The UE may update a Bj value, which should be processed per logical channel (data, which should be processed for a logical channel j), by using the parameters. The Bj value may be used in a first step of the logical channel prioritization process, and the UE may allocate resources to logical channels in priority group 2 having a Bj value larger than 0 according to priorities thereof in the first step of the logical channel prioritization. Furthermore, the Bj value is reduced by allocated resources. If there are remaining resources after the first step, the resources may be allocated such that all the remaining data of respective logical channels is transmitted according to priorities of the logical channels in priority group 2 regardless of the Bj value in a second step of the logical channel prioritization.

If there are remaining resources, which have not been allocated, after step 1650, a MAC CE having a lower priority than the data for the remaining resources may be inserted into the MAC PDU in step 1660. At this time, if resources of the allocated MAC PDU are not large enough to include all of the corresponding MAC CE, the corresponding MAC CE cannot be included. Also, when the corresponding MAC CE does not exist, the corresponding MAC CE cannot be included. The MAC CE having a lower priority than data may be a recommended bit rate (RBR) query MAC CE or a padding BSR MAC CE. If there are remaining resources, which have not been allocated, after step 1660, padding for the remaining resources may be inserted into the MAC PDU in step 1670.

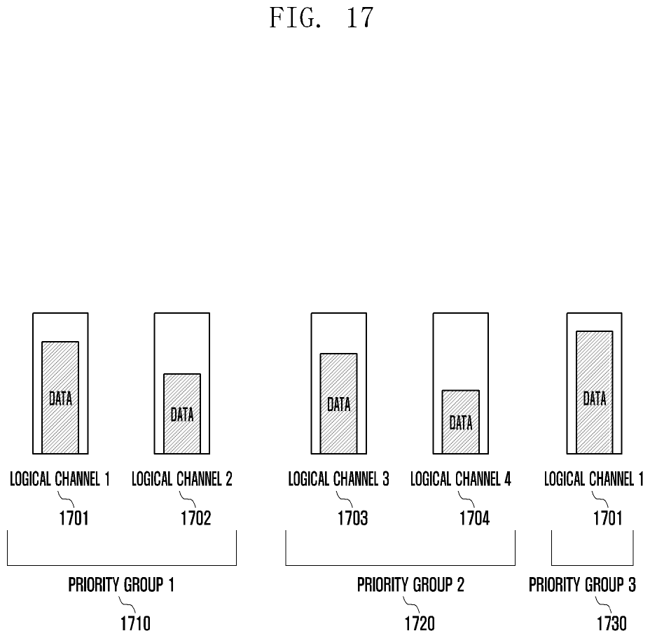

FIG. 17 illustrates a method of configuring a priority group of a logical channel proposed in the disclosure. As illustrated in FIGS. 13 and 14, a logical channel for processing data has a lower priority than some MAC CEs and thus, if the corresponding MAC CEs are generated, data transmission is delayed and the performance deteriorates. In order to solve the problem, the disclosure proposes a method of designating priority groups of the logical channels and giving relatively different priorities to the priority groups with respect to the MAC CE. The embodiments of FIGS. 15 and 16 propose configuration of two priority groups, but the priority groups may be expanded to three or more priority groups. In the embodiment of FIG. 17, it is assumed that five logical channels 1701, 1702, 1703, 1704, and 1705 are configured and three priority groups 1710, 1720, and 1730 are configured. Logical channel #1 1701 and logical channel #2 1702 are classified as priority group #1 1710 since they are logical channels which need to have a higher priority than some MAC CEs, logical channel #3 1703 and logical channel #4 1704 are classified as priority group #2 1720 since they are logical channels which may have a general priority, and logical channel #5 1705 is classified as priority group #3 1730 since is it a logical channel which may have a low priority. The term “priority” is a general priority for first processing rather than a priority value assigned in each logical channel configuration.

When the three priority groups are divided, each priority group has the following characteristics:
Priority group 1: is processed to have a priority lower than CCCH data or some MAC CEs which require a very high priority but is processed to have a higher priority than a MAC CE that requires a medium priority, a MAC CE that requires a low priority, a MAC CE that requires a lower priority, and data in priority groups 2 and 3.
Priority group 2: is processed to have a lower priority than CCCH data or some MAC CEs that require a very high priority, data in priority group 1, and a MAC CE that requires a medium priority but is processed to have a higher priority than other MAC CEs that requires a low priority or a lower priority.
Priority group 3: is processed to have a lower priority than CCCH data or a MAC CE that requires a high priority, data in priority groups 1 and 2, a MAC CE that requires a medium priority, and a MAC CE that requires a low priority but is processed to have a higher priority than other MAC CEs that requires a lower priority.

In some embodiments, the order applied in the logical channel prioritization process is described below (in order of priority from the highest priority):
C-RNTI MAC CE or UL-CCCH data
Configured grant confirmation MAC CE
Logical channel data in priority group 1
BSR MAC CE which is not padding BSR
Single entry PHR or multiple entry PHR MAC CE
Logical channel data in priority group 2
Recommended bit rate query MAC CE
Logical channel data in priority group 3
Padding BSR

However, the order does not necessarily have to be the same as the example, and each priority group only needs to have a separate prioritization order. In a method of separating priority groups of respective logical channels, the priority group may be configured when the logical channel is configured or the priority group may be configured by a preset rule similar to the method described in FIG. 15.

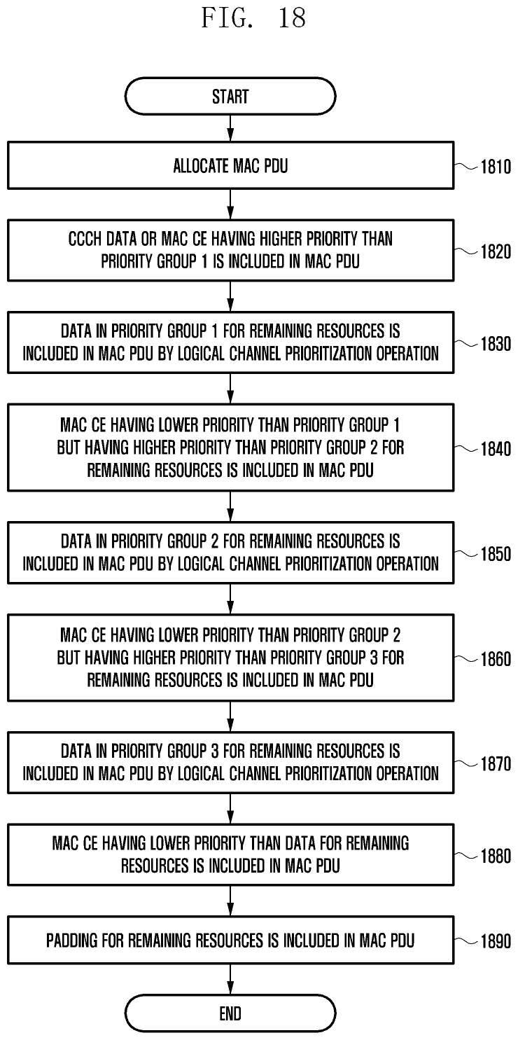

FIG. 18 illustrates a logical channel prioritization method according to a priority group configuration proposed in the disclosure. The embodiment of FIG. 18 may be a detailed operation of the embodiment in which there are three priority groups as illustrated in FIG. 17. The UE may receive allocation of the MAC PDU in step 1810. Thereafter, CCCH data or a MAC CE having a higher priority than data in priority group 1, which is not the CCCH, is inserted into a MAC PDU in step 1820. At this time, if resources of the allocated MAC PDU are not large enough to include CCCH data or the MAC CE, the corresponding CCCH data or the MAC CE cannot be included. If there is no CCCH data or no MAC CE having a higher priority than data, which is not the CCCH, the corresponding CCCH data or the MAC CE may not be included. The MAC CE having a higher priority than data in priority group 1, which is not the CCCH, may be a C-RNTI MAC CE or a configured grant confirmation MAC CE.

If there are remaining resources, which have not been allocated, after step 1820, data in priority group 1, which is not the CCCH, may be included in the MAC PDU for the remaining resources according to the logical channel prioritization operation in step 1830. When the corresponding logical channel is configured for the logical channel prioritization process, relevant parameters may be received from the BS through an RRC message. The corresponding parameters may be a prioritized bit rate (PBR), bucket size duration (BSD), and a priority. The UE may update a Bj value, which should be processed per logical channel (data, which should be processed for a logical channel j), by using the parameters. The Bj value may be used in a first step of the logical channel prioritization process, and the UE may allocate resources to logical channels in priority group 1 having a Bj value larger than 0 according to priorities thereof in the first step of the logical channel prioritization. Furthermore, the Bj value is reduced by allocated resources. If there are remaining resources after the first step, the resources may be allocated such that all the remaining data of respective logical channels is transmitted according to priorities of the logical channels in priority group 1 regardless of the Bj value in a second step of the logical channel prioritization.

If there are remaining resources, which have not been allocated, after step 1830, a MAC CE having a lower priority than priority group 1 but a higher priority than priority group 2 for the remaining resources may be included in the MAC PDU in step 1840. At this time, if resources of the allocated MAC PDU are not large enough to include all of the corresponding MAC CE, the corresponding MAC CE cannot be included. Also, when the corresponding MAC CE does not exist, the corresponding MAC CE cannot be included. The MAC CE having a lower priority than priority group 1 but a higher priority than priority group 2 may be a buffer status report (BSR) which is not padding, a single entry power headroom report (PHR), or a multiple entry PHR.

If there are remaining resources, which have not been allocated, after step 1840, data in priority group 2, which is not the CCCH, may be inserted into the MAC PDU for the remaining resources according to the logical channel prioritization operation in step 1850. When the corresponding logical channel is configured for the logical channel prioritization process, relevant parameters may be received from the BS through an RRC message. The corresponding parameters may be a prioritized bit rate (PBR), bucket size duration (BSD), and a priority. The UE may update a Bj value, which should be processed per logical channel (data, which should be processed for a logical channel j), by using the parameters. The Bj value may be used in a first step of the logical channel prioritization process, and the UE may allocate resources to logical channels in priority group 2 having a Bj value larger than 0 according to priorities thereof in the first step of the logical channel prioritization. Furthermore, the Bj value is reduced by allocated resources. If there are remaining resources after the first step, the resources may be allocated such that all the remaining data of respective logical channels is transmitted according to priorities of the logical channels in priority group 2 regardless of the Bj value in a second step of the logical channel prioritization.

If there are remaining resources, which have not been allocated, after step 1850, a MAC CE having a lower priority than priority group 2 but a higher priority than priority group 3 for the remaining resources may be included in the MAC PDU in step 1860. At this time, if resources of the allocated MAC PDU are not large enough to include all of the corresponding MAC CE, the corresponding MAC CE cannot be included. Also, when the corresponding MAC CE does not exist, the corresponding MAC CE cannot be included. The MAC CE having a lower priority than priority group 2 but a higher priority than priority group 3 may be a recommended bit rate (RBR) query MAC CE.

If there are remaining resources, which have not been allocated, after step 1860, data in priority group 3, which is not the CCCH, may be inserted into the MAC PDU for the remaining resources according to the logical channel prioritization operation in step 1870. When the corresponding logical channel is configured for the logical channel prioritization process, relevant parameters may be received from the BS through an RRC message. The corresponding parameters may be a prioritized bit rate (PBR), bucket size duration (BSD), and a priority. The UE may update a Bj value, which should be processed per logical channel (data, which should be processed for a logical channel j), by using the parameters. The Bj value may be used in a first step of the logical channel prioritization process, and the UE may allocate resources to logical channels in priority group 3 having a Bj value larger than 0 according to priorities thereof in the first step of the logical channel prioritization. Furthermore, the Bj value is reduced by allocated resources. If there are remaining resources after the first step, the resources may be allocated such that all the remaining data of respective logical channels is transmitted according to priorities of the logical channels in priority group 3 regardless of the Bj value in a second step of the logical channel prioritization.

If there are remaining resources, which have not been allocated, after step 1870, a MAC CE having a lower priority than the data for the remaining resources may be inserted into the MAC PDU in step 1880. At this time, if resources of the allocated MAC PDU are not large enough to include all of the corresponding MAC CE, the corresponding MAC CE cannot be included. Also, when the corresponding MAC CE does not exist, the corresponding MAC CE cannot be included. The MAC CE having a lower priority than data may be a padding BSR MAC CE. If there are remaining resources, which have not been allocated, after step 1880, padding for the remaining resources may be inserted into the MAC PDU in step 1890.

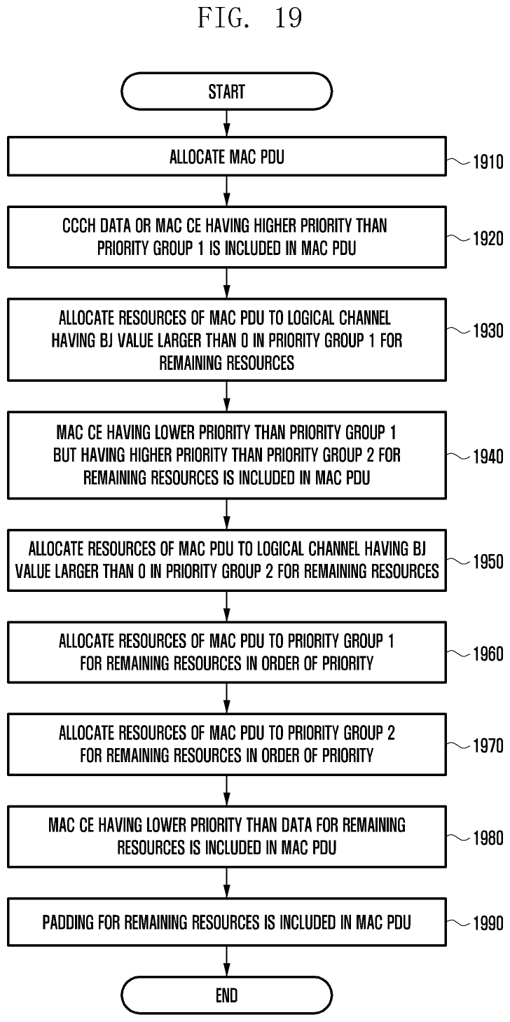

FIG. 19 illustrates another embodiment of the logical channel prioritization method according to the priority group configuration proposed in the disclosure. The embodiment of FIG. 19 may be a detailed operation of the embodiment in which there are two priority groups as illustrated in FIG. 15. The UE may receive allocation of the MAC PDU in step 1910. Thereafter, CCCH data or a MAC CE having a higher priority than data in priority group 1, which is not the CCCH, is first included in a MAC PDU in step 1920. At this time, if resources of the allocated MAC PDU are not large enough to include CCCH data or the MAC CE, the corresponding CCCH data or the MAC CE cannot be included. If there is no CCCH data or no MAC CE having a higher priority than data, which is not the CCCH, the corresponding CCCH data or the MAC CE may not be included. The MAC CE having a higher priority than data in priority group 1, which is not the CCCH, may be a C-RNTI MAC CE or a configured grant confirmation MAC CE.

If there are remaining resources, which have not been allocated, after step 1920, data in priority group 1, which is not the CCCH, may be included in the MAC PDU for the remaining resources according to the logical channel prioritization operation in step 1930. When the corresponding logical channel is configured for the logical channel prioritization process, relevant parameters may be received from the BS through an RRC message. The corresponding parameters may be a prioritized bit rate (PBR), bucket size duration (BSD), and a priority. The UE may update a Bj value, which should be processed per logical channel (data, which should be processed for a logical channel j), by using the parameters. The Bj value may be used in a first step of the logical channel prioritization process, and the UE may allocate resources to logical channels in priority group 1 having a Bj value larger than 0 according to priorities thereof in the first step of the logical channel prioritization. Furthermore, the Bj value is reduced by allocated resources. In the embodiment of FIG. 19, even though there are remaining resources after the first step of the logical channel prioritization, a second step of the logical channel prioritization is not performed.

If there are remaining resources, which have not been allocated, after step 1930, a MAC C having a lower priority than priority group 1 but a higher priority than priority group 2 for the remaining resources may be included in the MAC PDU in step 1940. At this time, if resources of the allocated MAC PDU are not large enough to include all of the corresponding MAC CE, the corresponding MAC CE cannot be included. Also, when the corresponding MAC CE does not exist, the corresponding MAC CE cannot be included. The MAC CE having a lower priority than priority group 1 but a higher priority than priority group 2 may be a buffer status report (BSR) which is not padding, a single entry power headroom report (PHR), or a multiple entry PHR.

If there are remaining resources, which have not been allocated, after step 1940, data in priority group 2, which is not the CCCH, may be included in the MAC PDU for the remaining resources according to the logical channel prioritization operation in step 1950. When the corresponding logical channel is configured for the logical channel prioritization process, relevant parameters may be received from the BS through an RRC message. The corresponding parameters may be a prioritized bit rate (PBR), bucket size duration (BSD), and a priority. The UE may update a Bj value, which should be processed per logical channel (data, which should be processed for a logical channel j), by using the parameters. The Bj value may be used in a first step of the logical channel prioritization process, and the UE may allocate resources to logical channels in priority group 2 having a Bj value larger than 0 according to priorities thereof in the first step of the logical channel prioritization. Furthermore, the Bj value is reduced by allocated resources. In the embodiment of FIG. 19, even though there are remaining resources after the first step of the logical channel prioritization, a second step of the logical channel prioritization is not performed.

If there are remaining resources, which have not been allocated, after step 1950, the resources may be allocated such that all the remaining data of respective logical channels in priority group 1 can be transmitted according to priorities of the logical channels regardless Bj in the second step of the logical channel prioritization in step 1960.

If there are remaining resources, which have not been allocated, after step 1960, the resources may be allocated such that all the remaining data of respective logical channels in priority group 2 can be transmitted according to priorities of the logical channels regardless Bj in the second step of the logical channel prioritization in step 1970.

If there are remaining resources, which have not been allocated, after step 1970, a MAC CE having a lower priority than the data for the remaining resources may be included in the MAC PDU in step 1980. At this time, if resources of the allocated MAC PDU are not large enough to include all of the corresponding MAC CE, the corresponding MAC CE cannot be included. Also, when the corresponding MAC CE does not exist, the corresponding MAC CE cannot be included. The MAC CE having a lower priority than data may be a recommended bit rate (RBR) query MAC CE or a padding BSR MAC CE. If there are remaining resources, which have not been allocated, after step 1980, padding for the remaining resources may be included in the MAC PDU in step 1990.

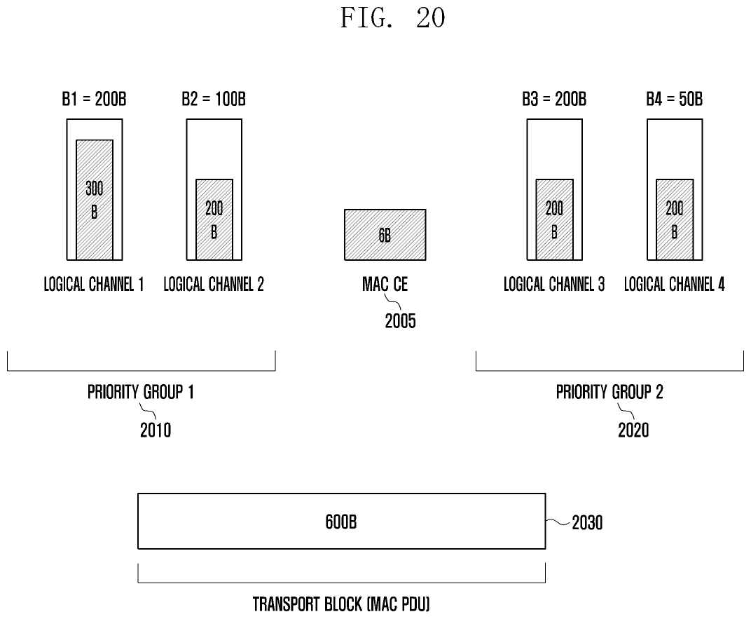

FIG. 20 illustrates an example of a logical channel prioritization method proposed in the disclosure. In the embodiment of FIG. 20, it is assumed that there are a total of four logical channels 2001, 2002, 2003, and 2004 and a MAC CE 2005 having a size of 6 bytes. It is assumed that logical channel #1 2001 and logical channel #2 2002 are priority group #1 2010, and logical channel #3 2003 and logical channel #4 2004 are priority group #2 2020. At this time, an amount of remaining data of the logical channel and a Bj value (j is a logical channel ID) are described below:
Logical channel 1: remaining data of 300 bytes and B1=200 bytes
Logical channel 2: remaining data of 200 bytes and B1=100 bytes
Logical channel 3: remaining data of 200 bytes and B1=200 bytes
Logical channel 4: remaining data of 200 bytes and B1=50 bytes

If the UE receives allocation of the MAC PDU 2030 having the size of 600 bytes, the UE performs the logical channel prioritization operation described in the embodiment of FIG. 16 or 19.

According to the embodiment of FIG. 16, the result of the logical channel prioritization operation by the UE is described below. In the disclosure, the size of a MAC sub header is ignored:
No CCCH data and no MAC CE which should be processed earlier than priority group 1
First step of logical channel prioritization for priority group 1
Allocate 200 bytes to logical channel 1
Allocate 100 bytes to logical channel 2
Second step of logical channel prioritization for priority group 1
Allocate 100 bytes to logical channel 1
Allocate 100 bytes to logical channel 2
Allocate 6 bytes to BSR
First step of logical channel prioritization for priority group 2
Allocate 94 bytes to logical channel 3
Complete resource allocation
No padding

According to the embodiment of FIG. 19, the result of the logical channel prioritization operation by the UE is described below. In the disclosure, the size of a MAC sub header is ignored:
No CCCH data and no MAC CE which should be processed earlier than priority group 1
First step of logical channel prioritization for priority group 1
Allocate 200 bytes to logical channel 1
Allocate 100 bytes to logical channel 2
Allocate 6 bytes to BSR
First step of logical channel prioritization for priority group 2
Allocate 200 bytes to logical channel 3
Allocate 50 bytes to logical channel 4
Second step of logical channel prioritization for priority group 1
Allocate 44 bytes to logical channel 1
Complete resource allocation
No padding

In the embodiment, there is no need to allocate resources to each logical channel by the accurate amount of the Bj value in the first step of the logical channel prioritization, and an appropriate value may be allocated according to an implementation. In this case, Bj may have a negative value.

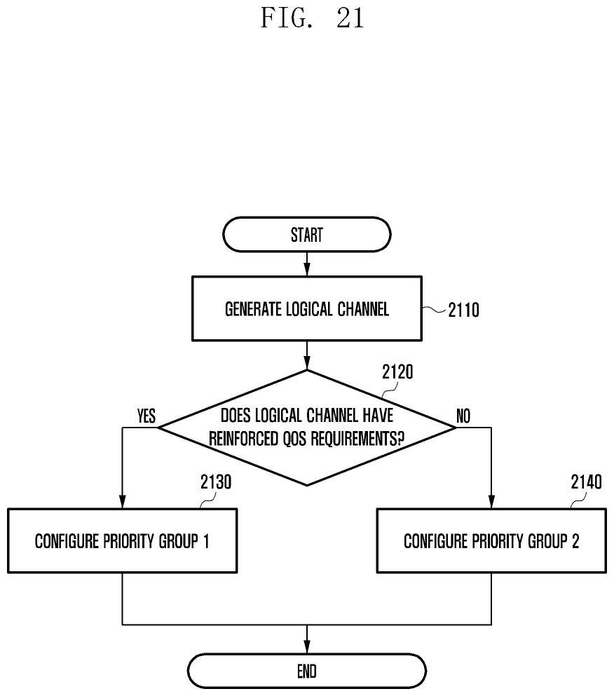

FIG. 21 illustrates an embodiment in which the BS allocates priority groups when logical channels are generated. As described above, when a plurality of priority groups are configured, a reference for determining the priority groups may be requirements of quality of service (QoS) which the logical channel should process. Accordingly, the logical channel is generated for the UE in step 2110. When the generated logical channel is configured, it may be identified whether the logical channel has reinforced requirements in consideration of the QoS requirements which the corresponding logical channel should process in step 2120. If the corresponding logical channel has the reinforced QoS requirements, the logical channel may be configured as priority group 1 so as to be preferentially processed by the UE in step 2130. If the corresponding logical channel does not need to have the reinforced QoS requirements, the logical channel may be configured as priority group 2 so as to be processed by the UE according to a general priority in step 2140.

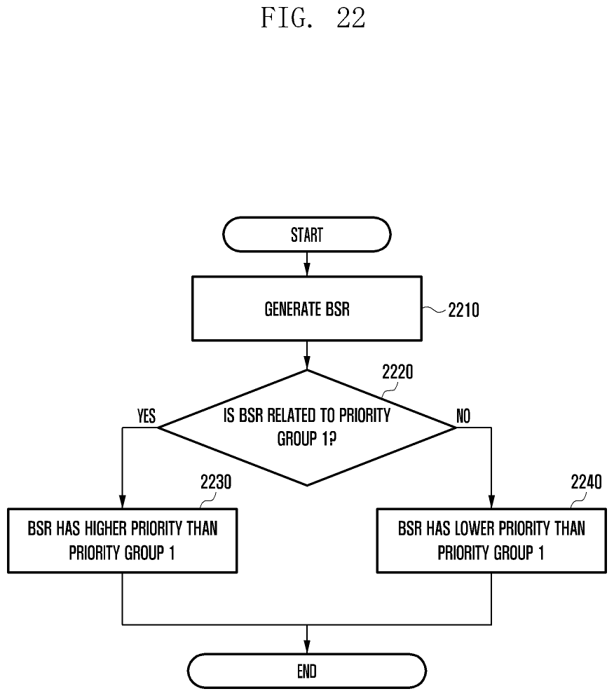

FIG. 22 illustrates an embodiment of a method of distinguishing BSRs having different priorities. Data of any logical channel may be processed earlier than a MAC CE such as a BSR according to the aforementioned priority group. However, in the case of any BSR, a report on the size of a buffer of a logical channel for processing URLLC service is needed and, in this case, the corresponding BSR has a higher priority and needs to be processed earlier than data in priority group 1. In the embodiment of FIG. 22, the BSR is referred to as a BSR related to priority group 1. The BSR related to priority group 1 may be a BSR corresponding to at least one of the following BSRs:
BSR triggered by data in priority group 1
BSR including buffer having size of 0 or larger for logical channel in priority group 1
BSR indicating there is data in logical channel in priority group 1
BSR triggered when logical channel in priority group 1 is configured

At this time, the BSR may be generated or triggered in step 2210. It may be determined whether the generated BSR is the BSR related to priority group 1 in step 2220. If the generated BSR is the BSR related to priority group 1, the BSR has a higher priority than priority group 1 and thus may be processed earlier than priority group 1 in step 2230. If the BSR is not the BSR related to priority group 1, the BSR has a lower priority than priority group 1 and thus may be processed after priority group 1 in step 2240.

In some embodiments, the order applied in the logical channel prioritization process is described below (in order of priority from the highest priority):
C-RNTI MAC CE or UL-CCCH data
Configured grant confirmation MAC CE
BSR MAC CE which is not padding BSR related to priority group 1
Logical channel data in priority group 1
BSR MAC CE which is not padding BSR which is not related to priority group 1
Single entry PHR or multiple entry PHR MAC CE
Logical channel data in priority group 2
Recommended bit rate query MAC CE
Logical channel data in priority group 3
Padding BSR

Although the embodiment of FIG. 22 describes relevance of priority group 1 with respect to only the BSR, the priority may be identified in consideration of relevance of priority group 1 with respect to a PHR.

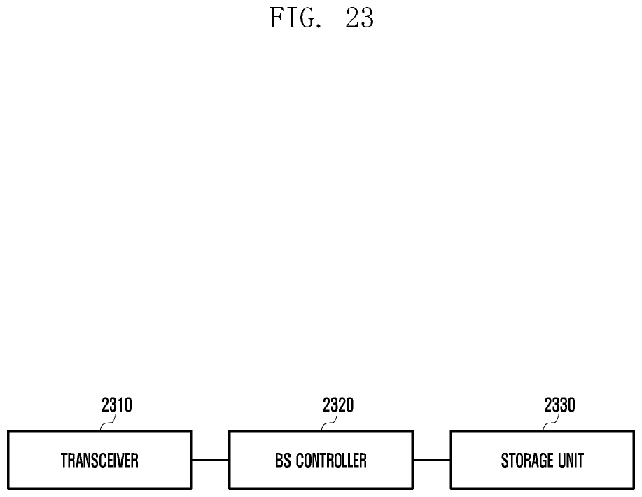

FIG. 23 illustrates a structure of a BS according to an embodiment of the disclosure.

Referring to FIG. 23, the BS may include a transceiver 2310, a controller 2320, and a storage unit 2330. In the disclosure, the controller 2320 may be defined as a circuit, an application-specific integrated circuit, or at least one processor.

The transceiver 2310 may transmit/receive a signal to/from another network entity. The transceiver 2310 may transmit, for example, system information to the UE and transmit a synchronization signal or a reference signal.

The controller 2320 may control the overall operation of the BS according to an embodiment proposed in the disclosure. For example, the controller 2320 may control a signal flow between blocks to perform the operation according to the above-described flowchart.

The storage unit 2330 may store at least one piece of information transmitted/received through the transceiver 2310 and information generated through the controller 2320.

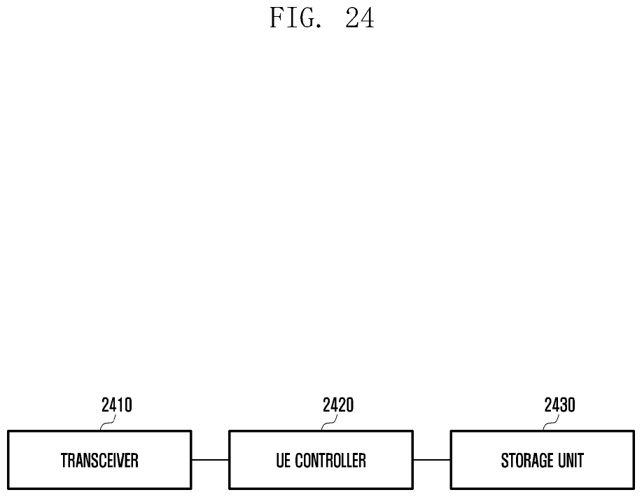

FIG. 24 illustrates a structure of a UE according to an embodiment of the disclosure.

Referring to FIG. 24, the UE may include a transceiver 2410, a controller 2420, and a storage unit 2430. In the disclosure, the controller may be defined as a circuit, an application-specific integrated circuit, or at least one processor.

The transceiver 2410 may transmit/receive a signal to/from another network entity. The transceiver 2410 may receive, for example, system information from the BS and receive a synchronization signal or a reference signal.

The controller 2420 may control the overall operation of the UE according to an embodiment proposed in the disclosure. For example, the controller 2420 may control a signal flow between blocks to perform the operation according to the above-described flowchart.

The storage unit 2430 may store at least one piece of information transmitted and received through the transceiver 2410 and information generated through the controller 2420.

Although specific embodiments have been described in the detailed description of the disclosure, various modifications and changes may be made thereto without departing from the scope of the disclosure. Therefore, the scope of the disclosure should not be defined as being limited to the embodiments, but should be defined by the appended claims and equivalents thereof.

1. A method of operating a first terminal, the method comprising:
transmitting, to a base station (BS), a first message including vehicle to everything (V2X)-related information on the first terminal;
receiving, from the BS, a second message including information for selecting a sidelink radio access technology (RAT), based on the first message; and
performing sidelink communication with a second terminal, based on RAT information.

2. The method of claim 1, further comprising transmitting, to the BS, a sidelink buffer status report (BSR) for the RAT, based on the RAT information,
wherein the BS allocates resources for the RAT, based on the sidelink BSR.

3. The method of claim 1, wherein the V2X-related information on the first terminal includes at least one of a use case indicator, a service ID, a destination ID, a group ID, a quality of service (QoS) indicator, an RAT capability of the first terminal, a service flow ID, a bearer ID, a 5G QoS indicator (5QI), a ProSe per-packet priority (PPPP), and a ProSe per-packet reliability (PPPR), and
wherein the information for selecting the sidelink RAT includes at least one of a sidelink RAT indicator, a frequency channel number, a TX profile, and a sidelink transmission scheme.

4. The method of claim 1, wherein the information for selecting the sidelink RAT includes an indicator indicating at least one of Release-14, Release-15, and Release-16,
wherein the indicator includes a TX profile corresponding to at least one of Release-14, Release-15, and Release-16, and
wherein the TX profile includes at least one of a modulation coding scheme (MCS), rate matching, transport block sizes (TBS) scaling, semi-persistent scheduling (SPS)/configured grant, and a one shot grant.

5. A method of operating a base station (BS), the method comprising:
receiving, from a first terminal, a first message including vehicle to everything (V2X)-related information on the first terminal; and
transmitting, to the first terminal, a second message including information for selecting a sidelink radio access technology (RAT), based on the first message,
wherein the first terminal performs sidelink communication with a second terminal, based on RAT information.

6. The method of claim 6, further comprising:
receiving, from the first terminal, a sidelink buffer status report (BSR) for the RAT, based on the RAT information; and
allocating resources for the RAT, based on the sidelink BSR.

7. The method of claim 6, wherein the V2X-related information on the first terminal includes at least one of a use case indicator, a service ID, a destination ID, a group ID, a quality of service (QoS) indicator, an RAT capability of the first terminal, a service flow ID, a bearer ID, a 5G QoS indicator (5QI), a ProSe per-packet priority (PPPP), and a ProSe per-packet reliability (PPPR), and
wherein the information for selecting the sidelink RAT includes at least one of a sidelink RAT indicator, a frequency channel number, a TX profile, and a sidelink transmission scheme.

8. The method of claim 6, wherein the information for selecting the sidelink RAT includes an indicator indicating at least one of Release-14, Release-15, and Release-16,
wherein the indicator includes a TX profile corresponding to at least one of Release-14, Release-15, and Release-16, and
wherein the TX profile includes at least one of a modulation coding scheme (MCS), rate matching, transport block sizes (TBS) scaling, semi-persistent scheduling (SPS)/configured grant, and a one shot grant.

9. A first terminal in a wireless communication system, the first terminal comprising:
a transceiver; and
a controller connected to the transceiver,
wherein the controller is configured to transmit, to a base station (BS), a first message including vehicle to everything (V2X)-related information on a first terminal, receive, from the BS, a second message including information for selecting a sidelink radio access technology (RAT), based on the first message, and perform sidelink communication with a second terminal, based on the RAT information.

10. The first terminal of claim 9, wherein the controller is configured to further transmit, to the BS, a sidelink buffer status report (BSR) for the RAT, based on the RAT information, and
wherein the BS allocates resources for the RAT, based on the sidelink BSR.

11. The first terminal of claim 9, wherein the V2X-related information on the first terminal includes at least one of a use case indicator, a service ID, a destination ID, a group ID, a quality of service (QoS) indicator, an RAT capability of the first terminal, a service flow ID, a bearer ID, a 5G QoS indicator (5QI), a ProSe per-packet priority (PPPP), and a ProSe per-packet reliability (PPPR), and
wherein the information for selecting the sidelink RAT includes at least one of a sidelink RAT indicator, a frequency channel number, a TX profile, and a sidelink transmission scheme.

12. The first terminal of claim 9, wherein the information for selecting the sidelink RAT includes an indicator indicating at least one of Release-14, Release-15, and Release-16,
wherein the indicator includes a TX profile corresponding to at least one of Release-14, Release-15, and Release-16, and
wherein the TX profile includes at least one of a modulation coding scheme (MCS), rate matching, transport block sizes (TBS) scaling, semi-persistent scheduling (SPS)/configured grant, and a one shot grant.

13. A base station (BS) in a wireless communication system, the BS comprising:
a transceiver; and
a controller connected to the transceiver,
wherein the controller is configured to receive, from a first terminal, a first message including vehicle to everything (V2X)-related information on the first terminal and transmit, to the first terminal, a second message including information for selecting a sidelink radio access technology (RAT), based on the first message, and the first terminal performs sidelink communication with a second terminal, based on RAT information.

14. The BS of claim 13, wherein the controller is configured to further receive a buffer status report (BSR) for the RAT from the first terminal, based on the RAT information and allocate resources for the RAT, based on the sidelink BSR.

15. The BS of claim 13, wherein the V2X-related information on the first terminal includes at least one of a use case indicator, a service ID, a destination ID, a group ID, a quality of service (QoS) indicator, an RAT capability of the first terminal, a service flow ID, a bearer ID, a 5G QoS indicator (5QI), a ProSe per-packet priority (PPPP), and a ProSe per-packet reliability (PPPR), and
wherein the information for selecting the sidelink RAT includes at least one of a sidelink RAT indicator, a frequency channel number, a TX profile, and a sidelink transmission scheme.
